(19) United States
(12) Patent Application Publication
(10) Pub. No.: US 2018/0260656 A1
(43) Pub. Date: Sep. 13, 2018

(54) ABNORMAL WAVEFORM SENSING SYSTEM, ABNORMAL WAVEFORM SENSING METHOD, AND WAVEFORM ANALYSIS DEVICE

(71) Applicant: HITACHI, LTD., Tokyo (JP)

(72) Inventors: Keiko OHKUBO, Tokyo (JP); Toshiaki SUZUKI, Tokyo (JP)

(21) Appl. No.: 15/903,116

(22) Filed: Feb. 23, 2018

(30) Foreign Application Priority Data
Mar. 8, 2017 (JP) 2017-044161

(51) Int. Cl. G06K 9/62; G06F 5/01; G06F 17/18

(52) U.S. Cl. CPC G06K 9/6203; G06K 9/6212; G06F 17/18; G06F 5/01

(57) ABSTRACT

The present invention includes acquiring an event point which is part of a reference waveform and which satisfies a predetermined condition, and extracting a singular point being part of the reference waveform in a period to which the acquired event point belongs, and has a value that indicates predetermined change, acquiring, when part of a target waveform corresponds to the event point, the part as a correspondence event point, and detecting a correspondence singular point in the period of the target waveform to which the correspondence event point belongs and corresponding to the singular point of the reference waveform, calculating a dissimilarity degree between a correction waveform generated based on the above four points and the reference waveform and the target waveform newly acquired, determining whether the target waveform has abnormality based on the dissimilarity degree, and outputting abnormality information.

### CROSS-REFERENCE TO RELATED APPLICATION

This application claims priority pursuant to 35 U.S.C. § 119 from Japanese Patent Application No. 2017-44161, filed on Mar. 8, 2017, the entire disclosure of which is incorporated herein by reference.

### BACKGROUND

The present invention relates to an abnormal waveform sensing system, an abnormal waveform sensing method, and a waveform analysis device.

In manufacturing industries, development of Internet of Things (IoT) progresses along with increasing request for predictive maintenance of facilities such as factories, and various kinds of data is collected from sensors provided to devices and the like and is accumulated. A large number of devices in manufacturing industries each repeatedly perform an identical operation, and temporally sequential measurement values obtained from a sensor provided to such a device repeat identical variation in synchronization with operation of the device. Thus, when temporally sequential data of measurement values is extracted in accordance with the period of operation of such a device, an identical waveform can be obtained in each period. In other words, an identical waveform repeatedly appears in the temporally sequential data acquired from the sensor, in synchronization with operation of the device. The technology of sensing abnormality of a device by analyzing such a repeatedly appearing waveform has been developed. Sensing abnormality of a device requires accumulation of a repeatedly appearing waveform that is learned in advance as a reference waveform and accurate extraction of a repeatedly appearing waveform of measurement values by comparing the measurement values to the accumulated reference waveform.

However, some devices perform an identical operation in different durations depending on season, weather, change of voltage applied to the devices, or an elapsed time since the devices are started, and the size of change in the measurement value of a sensor differs accordingly. As a result, an obtained waveform expands and contracts, for example, in the time axis direction and the measurement value axis direction. Such an expanded and contracted waveform differs from a reference waveform even when a device normally operates, which prevents accurate determination of the state of the device.

In view of this, Japanese Patent Laid-open Publication No. 2014-41453 discloses a method for correctly determining abnormality of an expanded and contracted waveform as described above (refer to pp. 5 and 6 and FIGS. 3 to 6). In this method, temporally sequential data of an analysis target which is accumulated in the past is expanded and contracted in the time axis direction and the measurement value axis direction. The similarity between the temporally sequential data and a reference waveform that indicates a waveform to be extracted is calculated by comparing the temporally sequential data with the reference waveform while adjusting part of the temporally sequential data that is used as a starting point, and a pair of an expansion/contraction ratio and a starting point, with which the similarity is highest, is obtained. In this manner, a repeatedly appearing waveform is accurately extracted from the temporally sequential data.

### SUMMARY

However, in the method of the above document, calculation of the similarity, the waveform expansion/contraction ratio, and the starting point, which are necessary for waveform extraction, requires acquisition of entire waveform data, and specifically, data for at least a time equivalent to the period of a waveform. Thus, the calculation of the similarity and the other values takes a long time, and sensing of abnormality of the waveform takes time accordingly.

The present invention has been made to solve the above-described problem and has an object to provide an abnormal waveform sensing system, an abnormal waveform sensing method, and a waveform analysis device that are capable of fast sensing abnormality of a waveform.

One of the present invention for solving the above-described problem is an abnormal waveform sensing system including a processor and a memory configured to sense abnormality of a target waveform which is a waveform serving as a target, based on a reference waveform which is a waveform serving as a reference and which has a value that changes in a predetermined period, the abnormal waveform sensing system comprising a reference part acquisition unit configured to acquire an event point which is part of the reference waveform and which satisfies a predetermined condition, and to extract a singular point which is part of the reference waveform and which exists in a period to which the acquired event point belongs, and has a value that indicates predetermined change, a target waveform acquisition unit configured to acquire the target waveform, a target waveform analysis unit configured to determine whether part of the acquired target waveform corresponds to the event point and to acquire, when having determined that part of the acquired target waveform corresponds to the event point, the part as a correspondence event point, and to detect a correspondence singular point which is part of the target waveform and which exists in the period of the target waveform to which the correspondence event point belongs, and corresponds to the singular point of the reference waveform, a dissimilarity degree calculation unit configured to generate a correction waveform obtained by correcting the reference waveform based on the acquired event point of the reference waveform, the extracted singular point of the reference waveform, the acquired correspondence event point of the target waveform, and the detected correspondence singular point of the target waveform, and to calculate a dissimilarity degree between the generated correction waveform and the target waveform newly acquired, an abnormality determination unit configured to determine whether the target waveform newly acquired has abnormality based on the calculated dissimilarity degree, and an alert output unit configured to output information related to the abnormality determination.

The present invention makes fast sensing of waveform abnormality possible.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF DRAWINGS

FIG. 1 is a diagram for description of an exemplary configuration of an abnormal waveform sensing system 1 according to Embodiment 1.

FIG. 2 is a diagram for description of an exemplary relation between a monitoring target device 105 and a sensor 104.

FIG. 3 is a diagram for description of exemplary hardware and function included in a waveform analysis device 101.

FIG. 4 is a diagram for description of exemplary hardware and function included in a data storage device 102.

FIG. 5 is a diagram illustrating an exemplary reference waveform data table 306.

FIG. 6 is a diagram illustrating an exemplary reference waveform feature value registration table 307.

FIG. 7 is a diagram illustrating an exemplary reference waveform in the present embodiment.

FIG. 8 is a diagram illustrating an exemplary measurement log table 308.

FIG. 9 is a diagram illustrating an exemplary current waveform measurement log table 309.

FIG. 10 is a diagram illustrating an exemplary current waveform feature value table 310.

FIG. 11 is a diagram illustrating an exemplary waveform log table 311.

FIG. 12 is a diagram illustrating an exemplary reference waveform registration screen 1001.

FIG. 13 is a sequence diagram for description of exemplary abnormal waveform sensing processing.

FIG. 14 is a flowchart for description of exemplary target waveform analysis processing.

FIG. 15 is a flowchart for description of the exemplary target waveform analysis processing.

FIG. 16 is a diagram illustrating exemplary reference waveform and target waveform for description of the target waveform analysis processing.

FIG. 17 is a diagram illustrating an exemplary screen that displays each temporally changing waveform in the target waveform analysis processing.

FIG. 18 is a diagram illustrating an exemplary reference waveform data table 306 according to Embodiment 2.

FIG. 19 illustrates an exemplary reference waveform feature value registration table 307 according to Embodiment 2.

FIG. 20 is a diagram illustrating an exemplary sensor registration screen.

FIG. 21 is a diagram illustrating an exemplary sensor reference waveform correspondence table 1801 storing a monitoring sensor 104A and a reference waveform in association.

FIG. 22 is a diagram illustrating an exemplary relation between a reference waveform 1901 and a target waveform 1902 when an event point is different from the starting point of the target waveform.

FIG. 23 is a diagram for description of exemplary target waveform analysis processing according to Embodiment 3.

FIG. 24 is a flowchart illustrating exemplary target waveform analysis processing according to Embodiment 4.

FIG. 25 is a flowchart illustrating exemplary target waveform analysis processing according to Embodiment 4.

FIG. 26 is a diagram illustrating an exemplary screen output in the target waveform analysis processing.

FIG. 27 is a diagram for description of a relation between an event point and a singular point, which is assumed in Embodiment 5.

FIG. 28 is a diagram illustrating an exemplary reference waveform feature value registration table 307 in the present embodiment.

FIG. 29 is a flowchart for description of processing performed in place of s1301 to s1306 in Embodiment 1 in the target waveform analysis processing according to the present embodiment.

FIG. 30 is a diagram for description of the principle of a high frequency component removal unit 221 according to Embodiment 6.

FIG. 31 is a diagram for description of the principle of a waveform processing method according to Embodiment 7.

FIG. 32 is a diagram illustrating an exemplary reference waveform data table 306 in the present embodiment.

FIG. 33 is a diagram illustrating an exemplary reference waveform feature value registration table 307 in the present embodiment.

FIG. 34 is a diagram illustrating an exemplary upper/lower value registration table 3001 storing information of an upper waveform and a lower waveform.

FIG. 35 is a diagram for description of the principle of a waveform processing method according to Embodiment 8.

FIG. 36 is a sequence diagram illustrating exemplary processing in which the waveform analysis device 101 performs feedback to the monitoring target device 105.

### DETAILED DESCRIPTION OF THE EMBODIMENTS

Embodiments of the present invention will be described below with reference to the accompanying drawings. In the embodiments, the number of elements or the like (for example, number, value, amount, or range) is not limited to a particular number unless, for example, explicitly indicated or clearly limited to the particular number in principle, but may be equal to, larger than, or smaller than the particular number.

In the embodiments, any component (for example, a function, a table, or an element step) is not necessarily essential unless, for example, explicitly indicated or clearly essential in principle.

The embodiments may be each applied alone, or a plurality or all of the embodiments may be applied in combination.

### Embodiment 1

### <System Configuration>

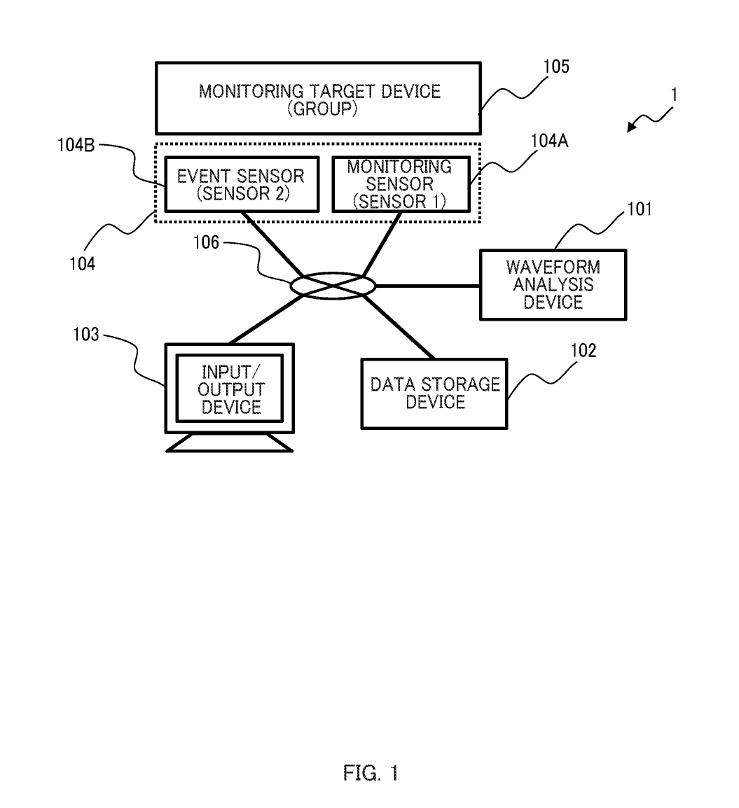

FIG. 1 is a diagram for description of an exemplary configuration of an abnormal waveform sensing system 1 according to Embodiment 1. The abnormal waveform sensing system 1 is provided as, for example, a state monitoring system of each device installed at a factory.

The abnormal waveform sensing system 1 includes a monitoring target device 105, a monitoring sensor 104A (hereinafter also referred to as a sensor 1), an event sensor 104B (hereinafter also referred to as a sensor 2), a waveform analysis device 101, a data storage device 102, and an input/output device 103. The waveform analysis device 101, the data storage device 102, the input/output device 103, the monitoring sensor 104A, and the event sensor 104B are coupled with each other through a network 106 to perform communication therebetween. The network 106 may or may not include a wired or wireless communication line or communication network such as a local area network (LAN), a wide area network (WAN), the Internet, an intranet, a leased line, a cellular phone network, or an optical fiber. For example, part or all of the above-described devices and sensors may be directly coupled with each other in a wireless or wired manner.

The monitoring target device 105 is, for example, one of various devices used for product manufacturing and configured to repeat periodic operation. Specifically, the monitoring target device 105 is at least one device (group) including a pressing machine, an NC working machine, a vacuum pump, and a robotic arm. The monitoring target device 105 may or may not be coupled with the network 106. The monitoring target device 105 may be coupled with a network other than the network 106.

The monitoring sensor 104A is, for example, an ammeter, a vibration meter, or a noise meter, and monitors periodic operation of the corresponding monitoring target device 105. The monitoring sensor 104A is coupled with the monitoring target device 105 or installed near the monitoring target device 105. The monitoring sensor 104A measures, as needed, a periodically changing physical quantity (such as a current value, a vibration value, or a noise value) such as current flowing inside the monitoring target device 105, vibration of the monitoring target device 105, or sound (such as noise) emitted by the monitoring target device 105, and acquires temporally sequential data of these measured values.

Such temporally sequential data acquired by the monitoring sensor 104A is referred to as a target waveform in the following.

The abnormal waveform sensing system 1 according to the present embodiment senses abnormality of the target waveform. A reference waveform to be described later is used as a reference for sensing abnormality of the target waveform.

The reference waveform is the waveform of temporally sequential data such as a current value, a vibration value, or a noise value measured by a predetermined sensor in advance. This waveform is, for example, the waveform of the monitoring sensor 104A acquired as a reference in advance when the monitoring target device 105 is normally operating.

Similarly to the target waveform, the reference waveform is a periodically changing waveform. However, the period of the target waveform is different from the period of the reference waveform in some cases, depending on the state and environment of the monitoring target device 105 such as a season, weather, voltage change of the device, and an elapsed time since the device is activated.

In this manner, the abnormal waveform sensing system 1 according to the present embodiment senses abnormality of a target waveform which is a waveform serving as a target, based on a reference waveform which is a waveform serving as a reference and which has a value that changes in a predetermined period.

The event sensor 104B is a position sensor, an angle sensor, or a passage sensor, and detects whether a predetermined condition is satisfied based on a measurement value thereof. Then, the event sensor 104B detects this satisfaction of the predetermined condition as an event and transmits information (hereinafter referred to as an event notification) indicating the detection to the waveform analysis device 101.

The above-described predetermined condition of an event is, for example, a condition related to operation of the monitoring target device 105. For example, the event sensor 104B monitors periodic operation of the monitoring target device 105 (such as vertical motion of a pressing machine, rotational motion of a gear, or operation of a robotic arm), and senses, as an event, passing of a predetermined part of the device through a predetermined position.

Since the monitoring target device 105 performs periodic operation as described above, temporally sequential data of a measurement value measured by the event sensor 104B is a periodic waveform. Accordingly, the timing when the event sensor 104B senses an event is a periodic timing.

The monitoring sensor 104A and the event sensor 104B (hereinafter collectively referred to as a sensor 104) includes, for example, the function of measuring vibration, current, noise, an angle, or the position of the monitoring target device 105, as needed, the analog/digital conversion function of converting a measurement value thereof into digital data, and the communication function of transmitting the converted data as temporally sequential data to the waveform analysis device 101 through the network 106.

The monitoring sensor 104A and the event sensor 104B may be each a single device or one of a plurality of devices.

Subsequently, the waveform analysis device 101 is an information processing device configured to analyze a waveform. The waveform analysis device 101 receives the temporally sequential data transmitted by the monitoring sensor 104A through the network 106, and detects abnormality of the monitoring target device 105 by using the received temporally sequential data and data read from the data storage device 102.

The waveform analysis device 101 detects an event by receiving an event notification transmitted from the event sensor 104B.

Reading and writing of data stored in the data storage device 102, which is performed by the waveform analysis device 101, is processing in accordance with a normal procedure, and thus a detailed description thereof will be omitted. Detailed description of communication processing between the waveform analysis device 101 and the data storage device 102, which occurs at data reading and writing, will be omitted too. In description of the present embodiment, the waveform analysis device 101 performs data reading and writing.

The input/output device 103 is an information processing device configured to receive inputting of information by a user or display and present a predetermined screen to the user. The input/output device 103 is coupled with the waveform analysis device 101 and the data storage device 102 to perform communication therebetween.

The data storage device 102 is an information processing device (for example, an external storage device) for performing data writing and reading and coupled with the waveform analysis device 101 and the input/output device 103. The data storage device 102 includes a data table recording data received from the sensor 104 and the like, which will be described later.

The configuration illustrated in FIG. 1 is merely exemplary. The waveform analysis device 101 and the data storage device 102 may be separate devices or an identical device. These devices may be provided on, for example, cloud (for example, a server on another network coupled with the abnormal waveform sensing system 1 to perform communication therebetween). Part or all of information stored in the data storage device 102 may be stored in the waveform analysis device 101. The waveform analysis device 101 and the data storage device 102 may be each a single device or one of a plurality of devices. The waveform analysis device 101 and the data storage device 102 may each include a plurality of devices.

<Relation Between Monitoring Target Device and Sensor>

The following specifically describes a relation between the monitoring target device 105 and the sensor 104 in the abnormal waveform sensing system 1.

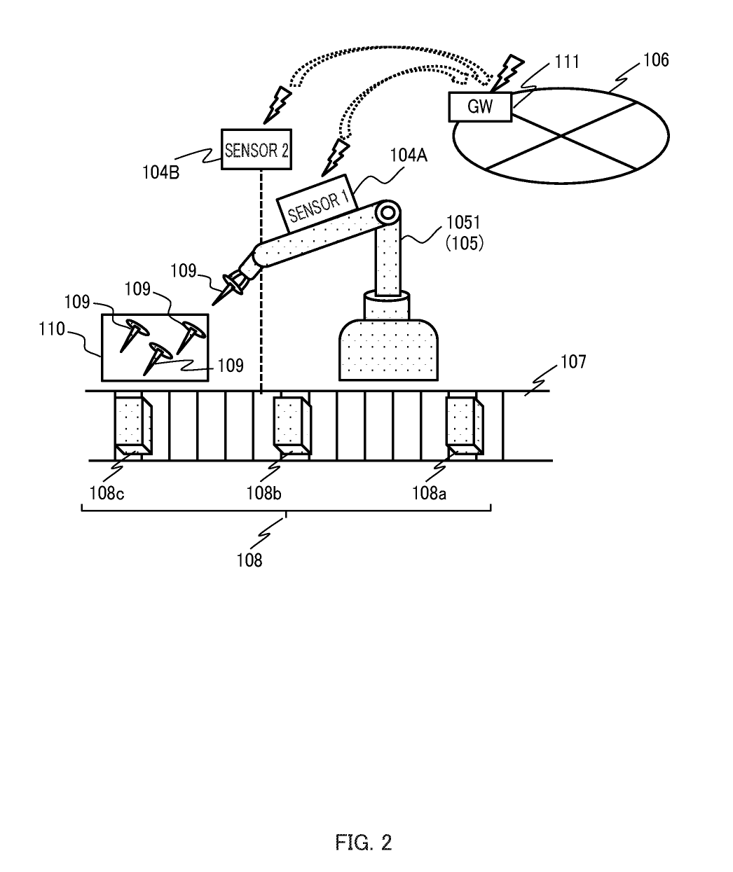

FIG. 2 is a diagram for description of an exemplary relation between the monitoring target device 105 and the sensor 104. As illustrated in FIG. 2, a robotic arm 1051 as an example of the monitoring target device 105 takes a component 109 from a table 110 installed adjacent to the robotic arm 1051, and mounts the component 109 to a component 108 on a belt conveyer 107.

The monitoring sensor 104A is a vibration sensor installed on the robotic arm 1051 and coupled with a gateway device 111 provided to the network 106 to perform communication therebetween. The monitoring sensor 104A measures vibration of the robotic arm 1051 and transmits a measurement value and a measurement date and time thereof and identification information of the monitoring sensor 104A to the waveform analysis device 101 through the gateway device 111 and the network 106. The measurement value of the monitoring sensor 104A is temporally sequential data as described above.

The event sensor 104B is a passage sensor coupled with the gateway device 111 to perform communication therebetween. The event sensor 104B detects, as an event, passing of the robotic arm 1051 through a particular position and transmits an event notification to the waveform analysis device 101 through the gateway device 111 and the network 106.

The following describes hardware and function included in the waveform analysis device 101.

### <Hardware and Function of Waveform Analysis Device 101>

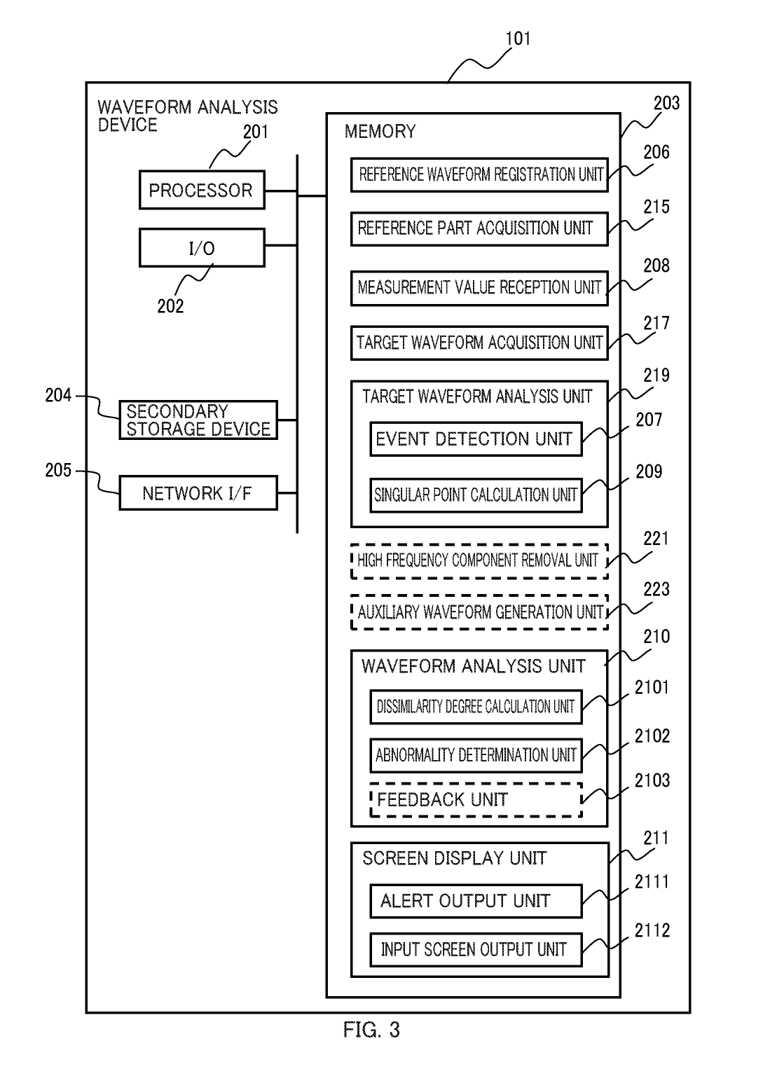

FIG. 3 is a diagram for description of exemplary hardware and function included in the waveform analysis device 101. The waveform analysis device 101 includes, as hardware, a processor 201 such as a central processing unit (CPU), an input/output interface 202 (I/O in FIG. 3) coupled with an input device (for example, a keyboard, a mouse, or a touch panel) and an output device (for example, a monitor (in other words, a display)), a network interface 205 (network I/F in FIG. 3) for performing communication with another device, a memory 203 including a storage region such as a random access memory (RAM) or a read only memory (ROM), and a secondary storage device 204 including a storage region such as a solid state drive (SSD) or a hard disk drive (HDD). The processor 201, the input/output interface 202, the memory 203, the secondary storage device 204, and the network interface 205 are coupled with each other through a bus to perform communication therebetween. Data stored in the memory 203 is also stored in, for example, the secondary storage device 204 for permanent data storage.

The waveform analysis device 101 includes functions of a reference waveform registration unit 206, a reference part acquisition unit 215, a measurement value reception unit 208, a target waveform acquisition unit 217, a target waveform analysis unit 219, a high frequency component removal unit 221, an auxiliary waveform generation unit 223, a waveform analysis unit 210, and a screen display unit 211.

The reference waveform registration unit 206 registers a reference waveform.

The reference part acquisition unit 215 acquires an event point which is part of the reference waveform and which satisfies a predetermined condition, and extracts a singular point which is part of the reference waveform and which exists in a period to which the extracted event point belongs, and has a value that indicates predetermined change (for example, a local maximum value, a local minimum value, change of the sign, or matching with a particular value).

The event point of the reference waveform is part of the reference waveform when a predetermined device performs a predetermined operation.

The singular point is part of the reference waveform where the reference waveform has, for example, a local maximum value, a local minimum value, a change point of the sign, or a value set in advance.

The reference part acquisition unit 215 selects, as the singular point, at least one of the above-described part extracted from the reference waveform so that the event point and the singular point are included in the reference waveform.

The measurement value reception unit 208 receives temporally sequential data (in other words, the target waveform) of a measurement value transmitted by the monitoring sensor 104A, and records the received temporally sequential data in a current waveform measurement log table 309 to be described later.

The target waveform acquisition unit 217 acquires the target waveform.

Specifically, the target waveform acquisition unit 217 acquires, as the value of the target waveform, a measurement value related to an operation periodically performed by the predetermined device.

The reference waveform and the target waveform each have a value that temporally changes in a predetermined period in an explicit manner.

The target waveform analysis unit 219 determines whether part of the acquired target waveform corresponds to the event point, acquires, when having determined that part of the acquired target waveform corresponds to the event point, the part as a correspondence event point, and detects a correspondence singular point which is the target waveform and which exists in the period of the target waveform to which the correspondence event point belongs, and corresponds to the singular point of the reference waveform.

The correspondence event point and the correspondence singular point correspond to the event point and the singular point, respectively, and always exist in an identical period of the target waveform when the target waveform is normal.

The target waveform analysis unit 219 outputs, when the correspondence singular point is not acquired, information indicating this acquisition result.

Specifically, the target waveform analysis unit 219 includes an event detection unit 207 and a singular point calculation unit 209.

The event detection unit 207 detects an event by acquiring the correspondence event point and performs setting of a predetermined timer and interrupt processing (to be described later in detail). The singular point calculation unit 209 calculates the correspondence singular point of the target waveform and cancels the timer set by the event detection unit 207.

The high frequency component removal unit 221 is an optionally provided function. The high frequency component removal unit 221 will be described in an embodiment to be described later.

The auxiliary waveform generation unit 223 is an optionally provided function. The auxiliary waveform generation unit 223 will be described in an embodiment to be described later.

The waveform analysis unit 210 detects abnormality of the target waveform based on the reference waveform and the target waveform. Specifically, the waveform analysis unit 210 includes a dissimilarity degree calculation unit 2101, an abnormality determination unit 2102, and a feedback unit 2103.

The dissimilarity degree calculation unit 2101 generates a correction waveform obtained by correcting the reference waveform based on the acquired event point of the reference waveform, the extracted singular point of the reference waveform, the acquired the correspondence event point of the target waveform, and the detected the correspondence singular point of the target waveform, and calculates a dissimilarity degree (hereinafter also referred to as an abnormality degree) between the generated correction waveform and the newly acquired target waveform.

Specifically, for example, the dissimilarity degree calculation unit 2101 generates the correction waveform based on a ratio (hereinafter referred to as a time axial expansion/contraction ratio) of a time difference between the correspondence event point and the correspondence singular point and a time difference between the singular point and the event point, and calculates the dissimilarity degree based on the generated correction waveform.

For example, the dissimilarity degree calculation unit 2101 generates the correction waveform based on a ratio (hereinafter referred to as a measurement value axial expansion/contraction ratio) of the value of the correspondence singular point and the value of the singular point, and calculates the dissimilarity degree based on the generated correction waveform. The measurement value axial expansion/contraction ratio may be a ratio of the value of the correspondence event point and the value of the event point.

The abnormality determination unit 2102 determines whether the target waveform newly acquired has abnormality based on the calculated dissimilarity degree.

For example, the abnormality determination unit 2102 calculates an allowable range of the target waveform based on the event point and the singular point, and determines that the target waveform newly acquired has abnormality when the target waveform newly acquired is out of the calculated allowable range.

The feedback unit 2103 is an optionally provided function. The feedback unit 2103 will be described in an embodiment to be described later.

The analysis of each waveform by the waveform analysis unit 210 described above is performed by, for example, analysis based on a Euclidean distance to be described later or correlation analysis.

The screen display unit 211 performs processing related to a screen output to (in other words, displayed on) the input/output device 103. Specifically, the screen display unit 211 includes an alert output unit 2111 and an input screen output unit 2112.

The alert output unit 2111 outputs information related to the abnormality determination.

For example, the alert output unit 2111 outputs the reference waveform, a waveform calculated based on the dissimilarity degree, and the acquired the target waveform, or outputs the target waveform, the waveform calculated based on the dissimilarity degree, and the reference waveform.

The input screen output unit 2112 outputs a screen for receiving inputting of the reference waveform.

The screen display unit 211 may be provided to, for example, the input/output device 103.

The following describes hardware and function included in the data storage device 102.

### <Hardware and Function Included in Data Storage Device 102>

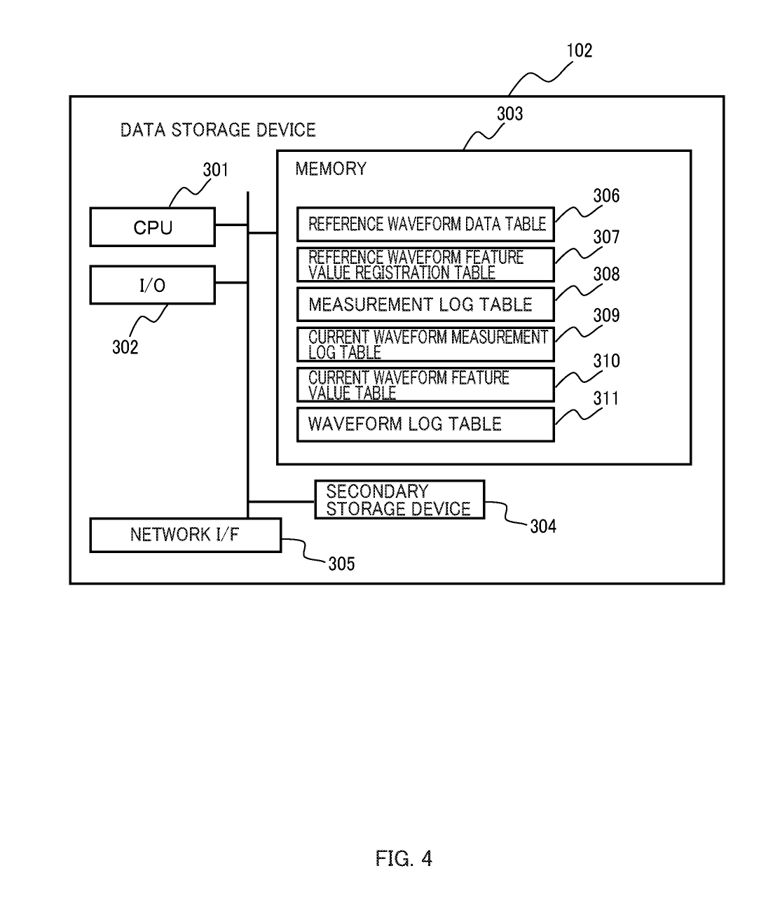

FIG. 4 is a diagram for description of exemplary hardware and function included in the data storage device 102. The data storage device 102 includes, as hardware, a processor 301 such as a central processing unit (CPU), an input/output interface 302 (I/O in FIG. 4) coupled with an input device (for example, a keyboard, a mouse, or a touch panel) and an output device (for example, a monitor (in other words, a display)), a network interface 305 (network I/F in FIG. 4) for performing communication with another device, a memory 303 including a storage region such as a random access memory (RAM) or a read only memory (ROM), and a secondary storage device 304 including a storage region such as a solid state drive (SSD) or a hard disk drive (HDD). The processor 301, the input/output interface 302, the memory 303, the secondary storage device 304, and the network interface 305 are coupled with each other through a bus to perform communication therebetween.

The data storage device 102 stores a reference waveform data table 306, a reference waveform feature value registration table 307, a measurement log table 308, the current waveform measurement log table 309, a current waveform feature value table 310, and a waveform log table 311.

The tables are described below in detail.

### <Reference Waveform Data Table>

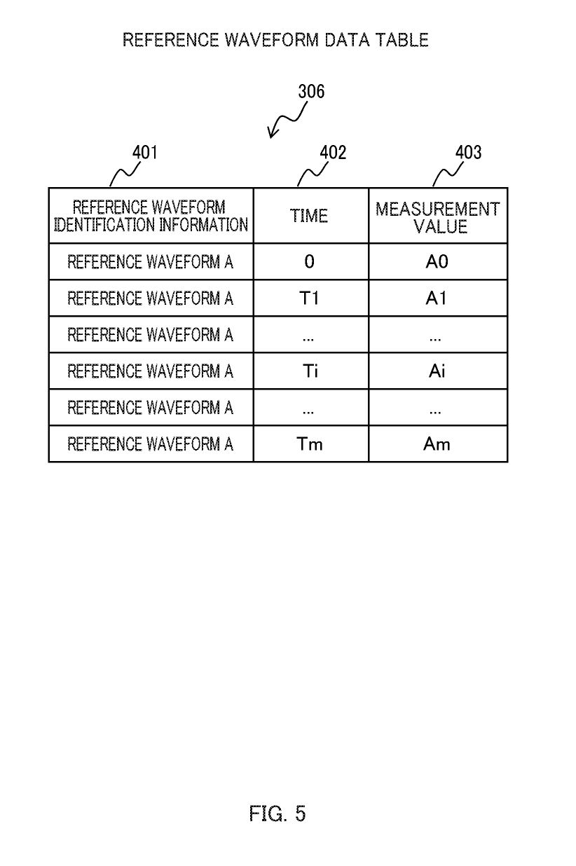

FIG. 5 is a diagram illustrating an exemplary reference waveform data table 306. The reference waveform data table 306 includes at least one entry (in other words, record) including the items of reference waveform identification information 401, a time 402, and a measurement value 403. The reference waveform identification information 401 stores information (hereinafter referred to as a reference waveform ID) for identifying each reference waveform. The time 402 stores an elapsed day and time or elapsed time (hereinafter referred to as a date and time) since the starting point of the reference waveform identified by the reference waveform identification information 401 (in other words, the starting point of the period of the reference waveform; a starting point indicates the starting point of a waveform period unless otherwise stated in the following). The measurement value 403 stores a measurement value of the reference waveform at a date and time indicated by the time 402. In FIG. 5, the number of reference waveforms is one (in the present embodiment, “reference waveform A”), but a plurality of reference waveforms may exist.

<Reference Waveform Feature Value Registration Table>

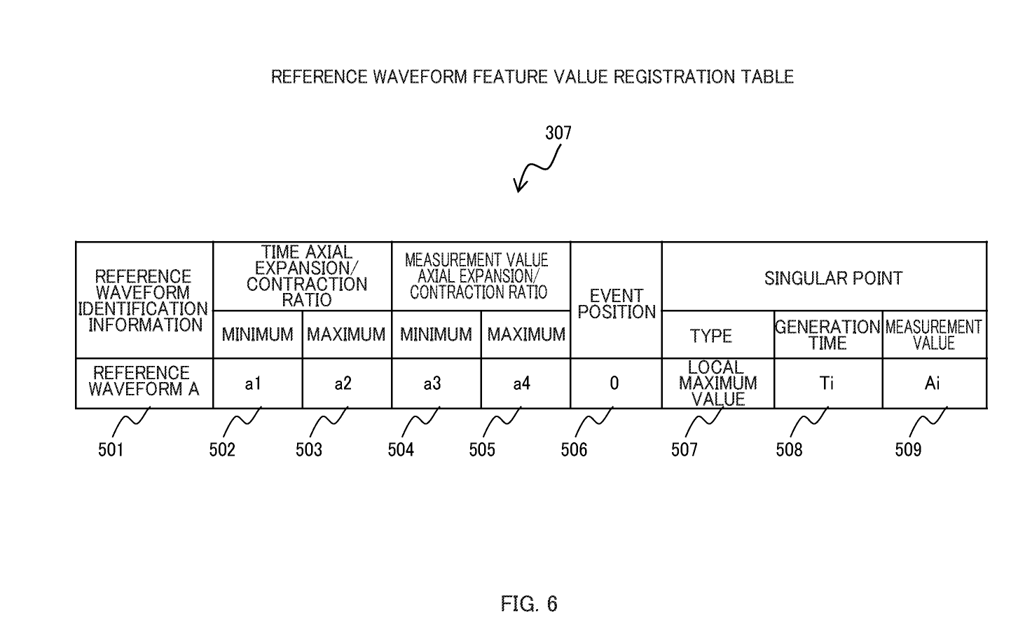

FIG. 6 is a diagram illustrating an exemplary reference waveform feature value registration table 307. As illustrated in FIG. 6, the reference waveform feature value registration table 307 includes at least one entry (in other words, record) including the items of reference waveform identification information 501, a minimum value 502, a maximum value 503, a minimum value 504, a maximum value 505, an event position 506, a type 507, a generation time 508, and a measurement value 509. The reference waveform identification information 501 stores a reference waveform ID. The minimum value 502 stores an allowed minimum value (hereinafter referred to as a time axial minimum expansion/contraction ratio) of the time axial expansion/contraction ratio. The maximum value 503 stores an allowed maximum value (hereinafter referred to as a time axial maximum expansion/contraction ratio) of the time axial expansion/contraction ratio. The minimum value 504 stores an allowed minimum value (hereinafter referred to as a measurement value axial minimum expansion/contraction ratio) of the measurement value axial expansion/contraction ratio. The maximum value 505 stores an allowed maximum value (hereinafter referred to as a measurement value axial maximum expansion/contraction ratio) of the measurement value axial expansion/contraction ratio. The event position 506 (“0” in the example illustrated in FIG. 6, in other words, the starting point) stores the date and time of an event point (hereinafter referred to as an event point date and time; in the present specification, the elapsed day and time or elapsed time since the starting point of the reference waveform). The type 507 stores information indicating the kind (for example, a local maximum value, a local minimum value, a change point of the sign of a measurement value, or a point where the measurement value takes a particular value) of a singular point. The generation time 508 stores the date and time (hereinafter referred to as a singular point date and time; in the present specification, the elapsed day and time or elapsed time since the starting point of the reference waveform) of the singular point indicated by the type 507. The measurement value 509 stores the value (in other words, the measurement value) of the reference waveform at the date and time indicated by the generation time 508.

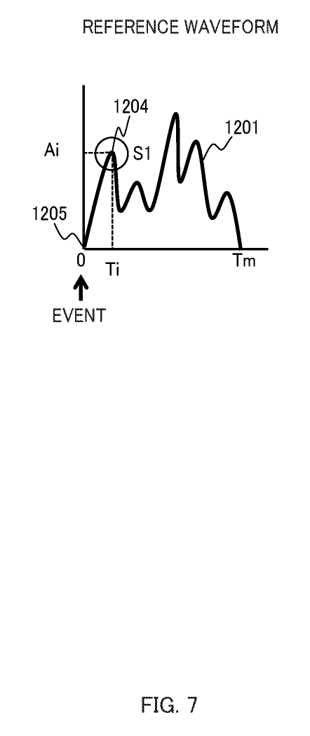

FIG. 7 is a diagram illustrating an exemplary reference waveform in the present embodiment. As illustrated in FIG. 7 this reference waveform 1201 has a period Tm and includes an event point 1205 and a singular point 1204. The event point date and time of the event point 1205 is zero, the singular point date and time of the singular point 1204 is Ti, and the value of the singular point 1204 is Ai.

In the present embodiment, the event point date and time coincides with the date and time of a starting point (in other words, the date and time of the starting point of the reference waveform, which is zero in the present specification).

Hereinafter, the contents of the reference waveform data table 306 and the reference waveform feature value registration table 307 described above are collectively referred to as reference waveform information.

<Measurement Log Table>

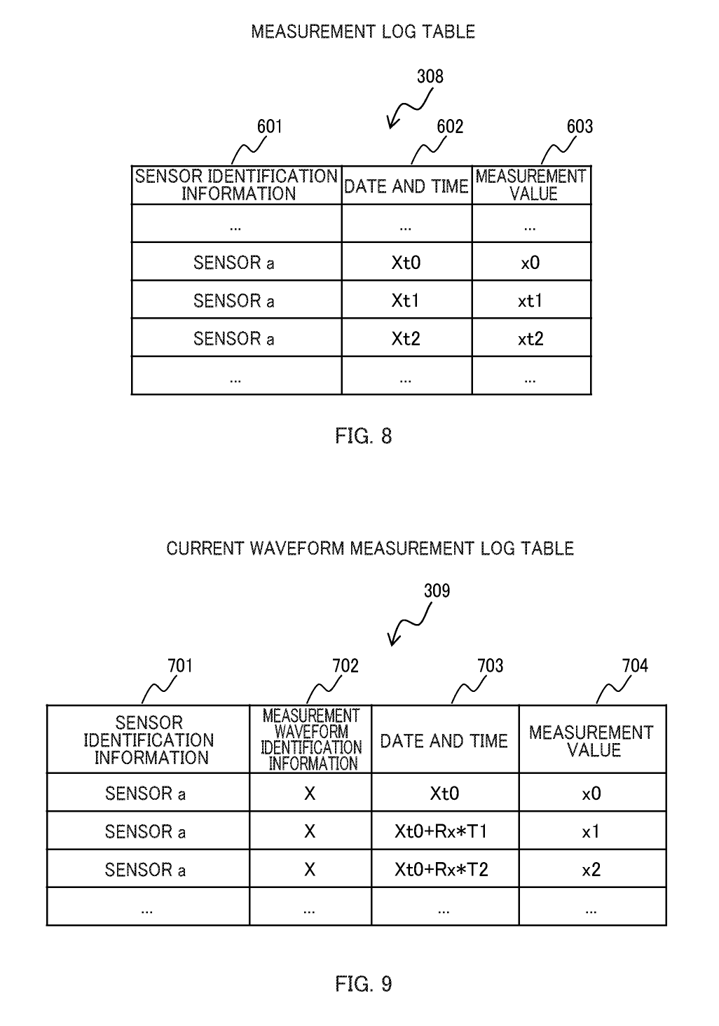

FIG. 8 is a diagram illustrating an exemplary measurement log table 308. The measurement log table 308 includes at least one entry (in other words, record) including the items of sensor identification information 601, a date and time 602, and a measurement value 603. The sensor identification information 601 stores information (hereinafter referred to as a sensor ID) for identifying the monitoring sensor 104A. The date and time 602 stores information of date and time. The measurement value 603 stores a measurement value of the sensor indicated by the sensor identification information 601, the value being measured at the date and time indicated by the date and time 602. In this manner, the measurement log table 308 stores measurement data of the monitoring sensor 104A in a temporally sequential manner.

<Current Waveform Measurement Log Table>

FIG. 9 is a diagram illustrating an exemplary current waveform measurement log table 309. The current waveform measurement log table 309 is a database in which the content of the measurement log table 308 is accumulated. The current waveform measurement log table 309 includes at least one entry (in other words, record) including the items of sensor identification information 701, measurement waveform identification information 702, a date and time 703, and a measurement value 704. The sensor identification information 701 stores a sensor ID. The measurement waveform identification information 702 stores information (hereinafter referred to as a target waveform ID) for identifying a target waveform represented by measurement values of the monitoring sensor 104A indicated by the sensor identification information 701. The date and time 703 stores date and time information. The measurement value 704 stores the measurement value of the sensor indicated by the sensor identification information 701.

<Current Waveform Feature Value Table>

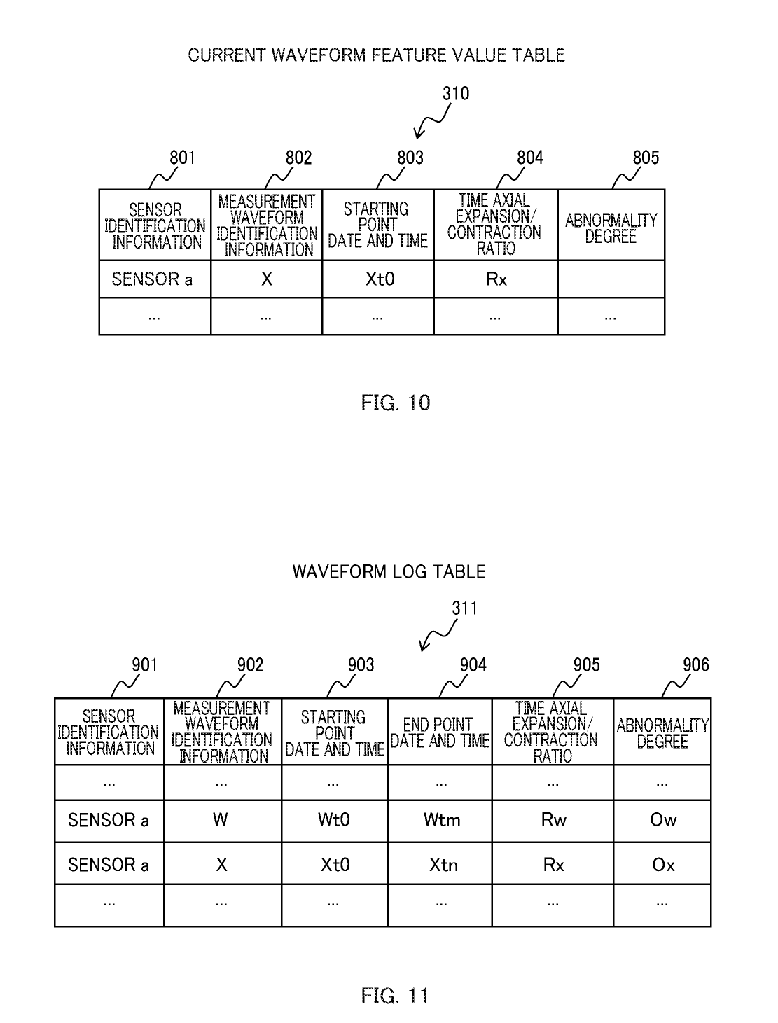

FIG. 10 is a diagram illustrating an exemplary current waveform feature value table 310. The current waveform feature value table 310 includes at least one entry (in other words, record) including the items of sensor identification information 801, measurement waveform identification information 802, a starting point date and time 803, a time axial expansion/contraction ratio 804, and an abnormality degree 805. The sensor identification information 801 stores a sensor ID. The measurement waveform identification information 802 stores a target waveform ID. The starting point date and time 803 stores information indicating the date and time of each starting point of the target waveform. The time axial expansion/contraction ratio 804 stores information indicating the time axial expansion/contraction ratio of a target waveform indicated by the measurement waveform identification information 802. The abnormality degree 805 stores information indicating the abnormality degree of the target waveform indicated by the measurement waveform identification information 802.

<Waveform Log Table>

FIG. 11 is a diagram illustrating an exemplary waveform log table 311. The waveform log table 311 is a database in which the content of the current waveform feature value table 310 is accumulated. The waveform log table 311 includes at least one entry (in other words, record) including the items of sensor identification information 901, measurement waveform identification information 902, a starting point date and time 903, an end point date and time 904, a time axial expansion/contraction ratio 905, and an abnormality degree 906. The sensor identification information 901 stores a sensor ID. The measurement waveform identification information 902 stores a target waveform ID. The starting point date and time 903 stores information indicating the date and time of each starting point of a target waveform. The end point date and time 904 stores information indicating the date and time of the end point of the target waveform (in other words, the end point of the period of the target waveform; an end point indicates the end point of a waveform unless otherwise stated in the following). The time axial expansion/contraction ratio 905 stores the time axial expansion/contraction ratio of a target waveform indicated by the measurement waveform identification information 902. The abnormality degree 906 stores the abnormality degree of the target waveform indicated by the measurement waveform identification information 902.

The configurations of the above-described tables are merely exemplary and do not limit the present invention. Addition or deletion of an item to each table may be performed as necessary.

The function of each information processing device described above is achieved by the hardware of the information processing device or by the processor of the information processing device reading and executing each computer program stored in the processor and memory.

This computer program may be stored in a storage device such as a secondary storage device, a non-transitory semiconductor memory, a hard disk drive, or an SSD, or in a computer-readable non-transitory data storage medium such as an IC card, an SD card, or a DVD.

<Processing>

The following describes processing performed at the abnormal waveform sensing system 1.

First, the abnormal waveform sensing system 1 performs processing of receiving registration of reference waveform information by, for example, an administrator, and subsequently performs processing of sensing abnormality of a target waveform based on the received reference waveform information.

The following first describes the registration of reference waveform information. The reference waveform information is set by, for example, a system administrator through the input/output device 103 in advance. A screen (hereinafter referred to as a reference waveform registration screen) for performing the setting and registration of reference waveform information will be described next.

<Reference Waveform Registration Screen>

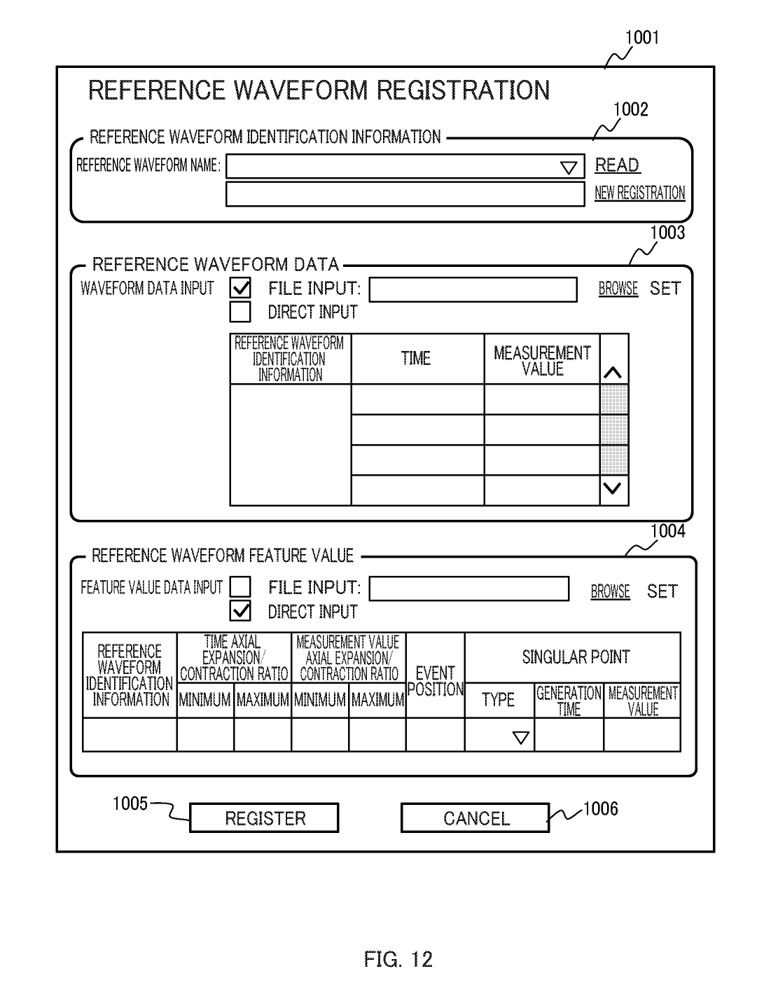

FIG. 12 is a diagram illustrating an exemplary reference waveform registration screen 1001. The reference waveform registration screen 1001 includes an input unit 1002 for reference waveform identification information, an input unit 1003 for reference waveform data, an input unit 1004 for a reference waveform feature value, a registration button 1005, and a cancel button 1006. The reference waveform registration screen 1001 is output to, for example, the display of the waveform analysis device 101 or the input/output device 103.

The input unit 1002 for reference waveform identification information receives selection of an already registered reference waveform or registration of a new reference waveform.

The input unit 1003 for reference waveform data specifies a file recorded in each information processing device and acquires, from the file, reference waveform information corresponding to information recorded in the reference waveform data table 306. The input unit 1003 for reference waveform data receives inputting of information corresponding to information recorded in the reference waveform data table 306 from a user.

The input unit 1004 for reference waveform feature value specifies a file recorded in each device and acquires, from the file, reference waveform information corresponding to information recorded in the reference waveform feature value registration table 307. The input unit 1004 for reference waveform feature value receives inputting of information from a user.

The registration button 1005 executes registration of reference waveform information. Specifically, upon inputting from a user through the registration button 1005, information input to the input unit 1003 for reference waveform data is registered in the reference waveform data table 306, and information input to the input unit 1004 for reference waveform feature value is registered in the reference waveform feature value registration table 307. When any of the tables already has registered information, the registration may be performed after the already registered information is deleted or after overwriting is confirmed.

The cancel button 1006 stops the registration of reference waveform information. Specifically, when inputting on the cancel button 1006 is performed by a user, processing ends without registration of information input on the reference waveform registration screen 1001. It may be confirmed whether to end the processing without the information registration.

The reference waveform registration screen 1001 may additionally include another input or display element. The reference waveform registration screen 1001 may be divided in a plurality of screens. Security management for outputting of the reference waveform registration screen 1001 may be performed by, for example, requesting inputting of an ID or a password by a user. Before the reference waveform registration screen 1001 is output, a screen (not illustrated) for selecting the reference waveform registration function may be output, or the reference waveform registration screen 1001 may be output after transition through a plurality of screens.

The following describes processing related to sensing of abnormality of a target waveform, which is performed based on reference waveform information registered as described above.

<<Abnormal Waveform Sensing Processing>>

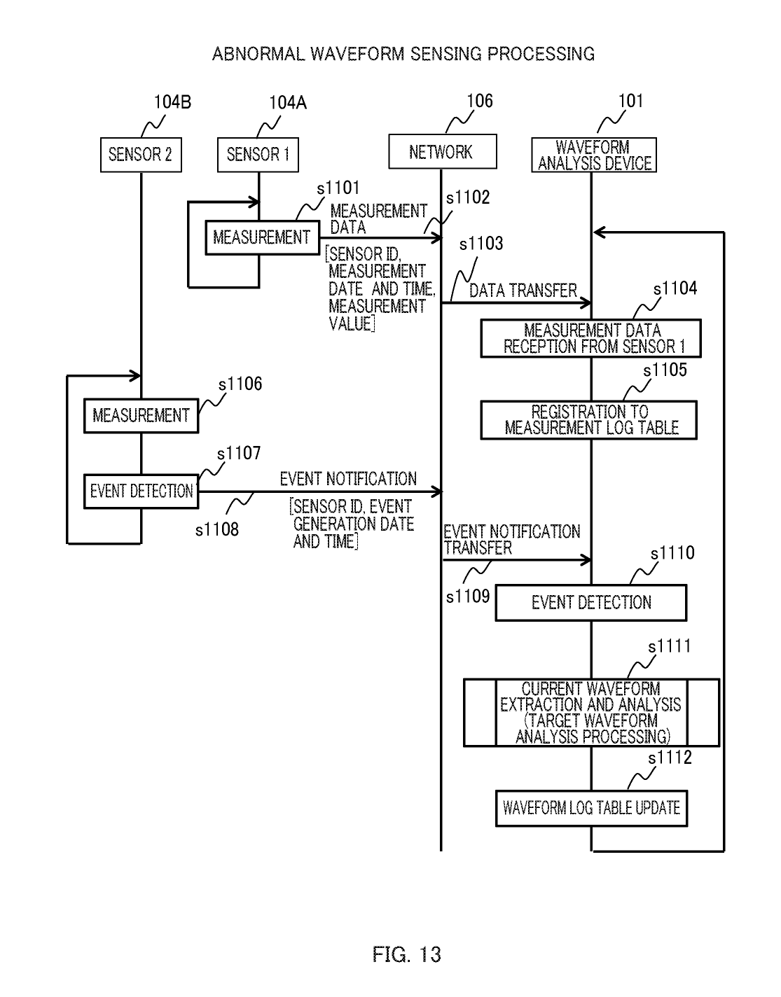

FIG. 13 is a sequence diagram for description of exemplary processing (hereinafter referred to as abnormal waveform sensing processing) of sensing abnormality of a target waveform by using a reference waveform, which is performed by the abnormal waveform sensing system 1. This processing is started, for example, when the sensor 104 and the waveform analysis device 101 are activated or when predetermined input to the input/output device 103 is performed.

As illustrated in FIG. 13, when the abnormal waveform sensing processing is started, the monitoring sensor 104A (the sensor 1) performs measurement related to operation of the monitoring target device 105 as needed (for example, at a timing set in advance or at a predetermined time interval) (s1101), and transmits, as measurement data, a measurement value obtained by this measurement to the waveform analysis device 101 through the network 106 (s1102 and s1103). This measurement data is transmitted together with the sensor ID of the monitoring sensor 104A and the measurement date and time of the measurement value.

When having received the measurement data from the monitoring sensor 104A (s1104), the measurement value reception unit 208 of the waveform analysis device 101 records the content of the received measurement data in the measurement log table 308 (s1105). Specifically, the measurement value reception unit 208 generates a new record in the measurement log table 308, and stores the sensor ID of the monitoring sensor 104A in the sensor identification information 601 of the generated record, the measurement date and time in the date and time 602, and the measurement value of the monitoring sensor 104A of in the measurement value 603. The temporally sequential data of this measurement value is expressed as a target waveform.

Similarly to the monitoring sensor 104A, the event sensor 104B (in other words, the sensor 2) performs monitoring (in other words, measurement) of an event related to the monitoring target device 105 as needed (for example, at a timing set in advance or at a predetermined time interval) (s1106). When having determined that the event has occurred (s1107), the event sensor 104B transmits an event notification to the waveform analysis device 101 through the network 106 (s1108 and s1109). The event notification is transmitted together with information on the sensor ID of the event sensor 104B and the generation date and time (hereinafter referred to as an event point date and time) of the event.

The event detection unit 207 of the waveform analysis device 101 detects the event by receiving the event notification transmitted from the event sensor 104B (s1110), and executes processing (hereinafter referred to as target waveform analysis processing) of analyzing the target waveform recorded at s1105 (s1111). This processing will be described later in detail.

After having executed the target waveform analysis processing, the waveform analysis unit 210 updates the waveform log table 311 (s1112). Specifically, the waveform analysis unit 210 adds the items of each record in the current waveform feature value table 310 to the corresponding items of each record in the waveform log table 311. When having determined that the target waveform has reached at an end point, the waveform analysis unit 210 stores the current date and time in the end point date and time 904 of the waveform log table 311. Thereafter, the processing at s1104 is repeated.

<<Target Waveform Analysis Processing>>

The following describes the target waveform analysis processing.

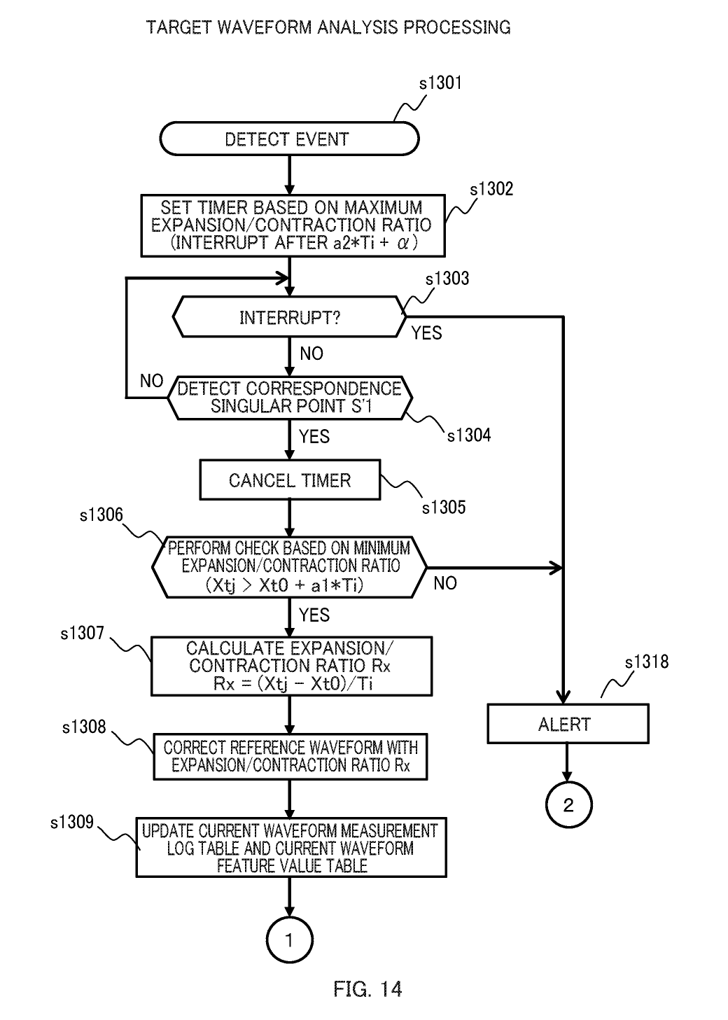

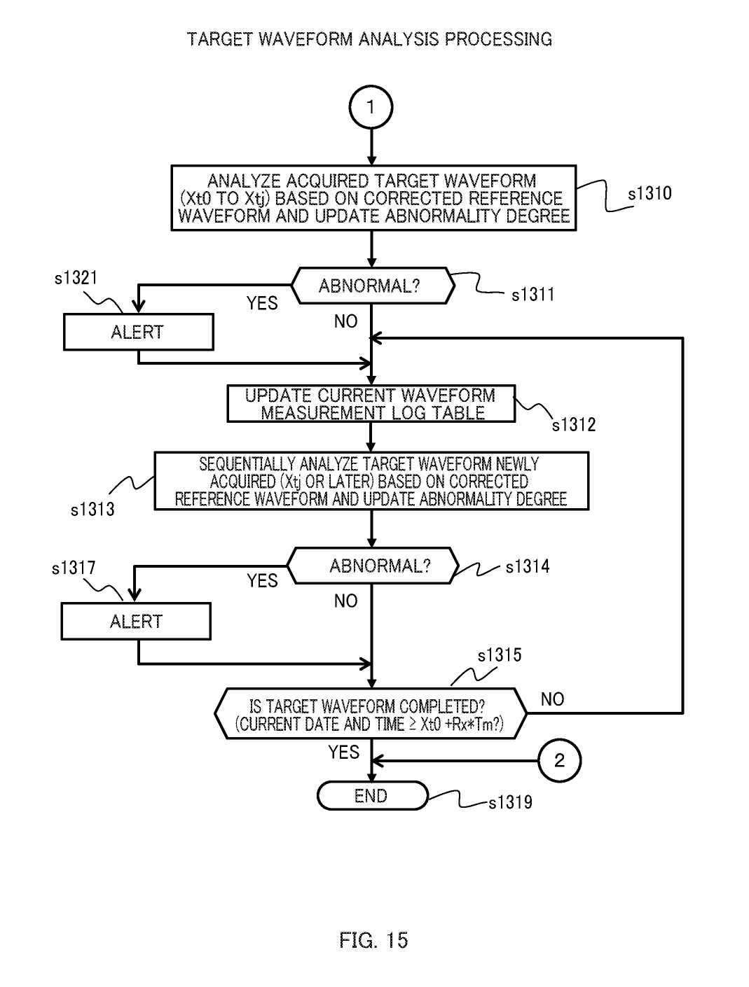

FIGS. 14 and 15 is a flowchart (divided in two sheets) for description of exemplary target waveform analysis processing.

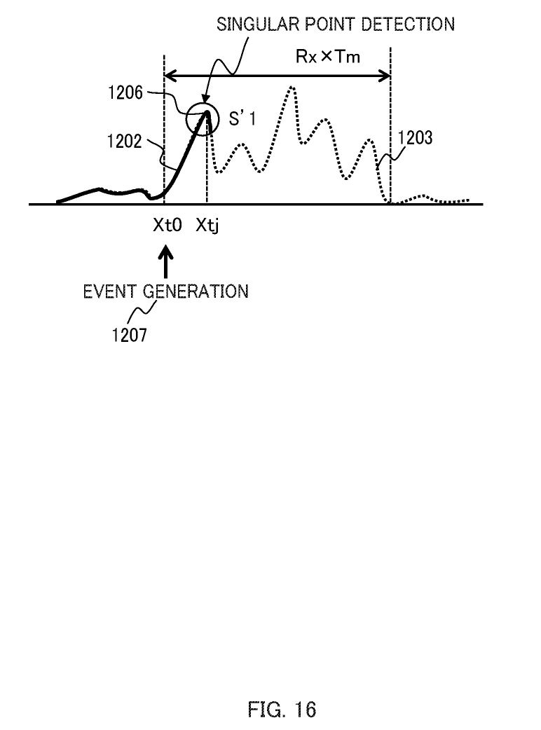

FIG. 16 is a diagram illustrating an exemplary reference waveform and an exemplary target waveform for description of the target waveform analysis processing.

The target waveform analysis processing will be described below with reference to FIGS. 14 and 15.

First, as illustrated in FIG. 14, the event detection unit 207 senses an event by receiving an event notification described above (s1301). Then, the event detection unit 207 stores a date and time indicated by the event notification as a correspondence event point date and time at a correspondence event point, and performs timer setting based on a time axial maximum expansion/contraction ratio for detecting a correspondence singular point (s1302).

For example, as illustrated in FIG. 16, when there is an already measured target waveform 1202 (solid line), the event detection unit 207 stores an event point date and time as a correspondence event point date and time by receiving an event notification recording an event point date and time Xt0 (1207), and acquires a time axial maximum expansion/contraction ratio a2 and a singular point generation date and time Ti (hereinafter referred to as a singular point date and time) from a record of a reference waveform (hereinafter referred to as the present reference waveform) corresponding to the monitoring sensor 104A in the reference waveform feature value registration table 307. The event detection unit 207 sets, by using the ratio and the date and time, a timer for performing interrupt after “a2×Ti+α” from the correspondence event point date and time Xt0 (where “+α” is, for example, a time necessary for sensing a local maximum value, a local minimum value, or the like of a waveform; this is the same in the following).

Then, the singular point calculation unit 209 continues the detection of a correspondence singular point of the target waveform based on temporally sequential data (in other words, the target waveform) received as needed at s1104 until the interrupt by the timer occurs in a period identical to the period of the target waveform to which the correspondence event point belongs (s1303 and s1304).

For example, as illustrated in FIG. 16, after detection a correspondence event point date and time 1207 of the target waveform, the singular point calculation unit 209 detects a correspondence singular point 1206 while receiving the target waveform 1202 as needed. The correspondence singular point 1206 is a local maximum value of the target waveform, and thus the singular point calculation unit 209 detects a point at which the measurement value of the target waveform makes transition from increasing to decreasing.

When having detected the correspondence singular point 1206 before an interrupt occurs (Yes at s1304), the singular point calculation unit 209 cancels the timer (s1305), and thereafter processing at s1306 is executed. When the singular point calculation unit 209 has not detected the correspondence singular point 1206 before an interrupt occurs (Yes at s1303), the waveform analysis unit 210 emits an alert (for example, outputs a predetermined warning text or sound; this is the same in the following) (s1318), and then the target waveform analysis processing ends (s1319).

At s1306, the singular point calculation unit 209 checks whether a generation date and time Xtj (hereinafter referred to as a correspondence singular point date and time) of the correspondence singular point detected at s1304 satisfies a condition based on a time axial minimum expansion/contraction ratio. For example, the singular point calculation unit 209 checks whether Expression (1) below is satisfied based on the correspondence event point date and time Xt0, a time axial minimum expansion/contraction ratio a1, and the singular point date and time Ti (in other words, elapsed day and time or elapsed time since the starting point of a reference waveform).

Xtj>Xt0+a1*Ti Expression (1)

When the correspondence singular point date and time Xtj satisfies the condition based on the time axial minimum expansion/contraction ratio, the singular point calculation unit 209 calculates a current expansion/contraction ratio Rx (in other words, a time axial expansion/contraction ratio) of the target waveform (Yes at s1306, and s1307). When the correspondence singular point date and time Xtj does not satisfy the condition based on the time axial minimum expansion/contraction ratio (No at s1306), the singular point calculation unit 209 emits an alert (s1318), and then the target waveform analysis processing ends (s1319).

The expansion/contraction ratio Rx can be obtained by, for example, Expression (2).

Rx=(Xtj−Xt0)/Ti Expression (2)

The expansion/contraction ratio Rx in a range indicated by the time axial minimum expansion/contraction ratio a1 and the time axial maximum expansion/contraction ratio a2 is obtained through the above-described condition determination.

Subsequently, the waveform analysis unit 210 corrects the present reference waveform by the expansion/contraction ratio Rx, and accordingly generates a correction waveform (s1308). The generated correction waveform is a prediction value of the target waveform. Specifically, for example, the waveform analysis unit 210 reads all records of the present reference waveform from the reference waveform data table 306, and multiplies the value of the time 402 in each read record by the expansion/contraction ratio Rx calculated at s1307.

In the example illustrated in FIG. 16, a correction waveform 1203 (dotted line) is calculated based on the present reference waveform and the time axial expansion/contraction ratio Rx.

Then, the waveform analysis unit 210 updates the current waveform measurement log table 309 (s1309). Specifically, the waveform analysis unit 210 acquires all measurement value records of the target waveform at or after a starting point (in other words, the correspondence event point date and time Xt0 in the present embodiment; hereinafter referred to as a starting point date and time Xt0) from among records in the measurement log table 308, and records data of the acquired records into respective records in the current waveform measurement log table 309. The waveform analysis unit 210 sets a predetermined target waveform ID to the target waveform (in the example illustrated in FIG. 9, “X” is set as a target waveform ID), and stores the set target waveform ID in the measurement waveform identification information 702 of the current waveform measurement log table 309.

In the example illustrated in FIG. 16, the waveform analysis unit 210 reads, from the measurement log table 308, data of each record of the target waveform 1202 acquired at or after the starting point date and time Xt0, and records the data in the current waveform measurement log table 309.

Instead of recording all measurement values at or after the starting point date and time Xt0 in the current waveform measurement log table 309, the waveform analysis unit 210 may selectively record a necessary measurement value (for example, a measurement value necessary for comparison with the present reference waveform to be described later) or may newly generate a measurement value record as necessary.

For example, the waveform analysis unit 210 records, in the current waveform measurement log table 309, a record that stores, in the date and time 703, a date and time corresponding to a date and time (in other words, elapsed day and time or elapsed time since the starting point of the reference waveform) recorded in a record of the reference waveform data table 306. For example, when no measurement value has a date and time (hereinafter referred to as a needed date and time) necessary for comparison with the present reference waveform, the waveform analysis unit 210 generates an approximate line of the target waveform based on a linear function by using measurement values measured before and after the needed date and time, calculates an interpolation value at the needed date and time based on the generated approximate line, and stores the needed date and time and the calculated interpolation value in a new record generated in the current waveform measurement log table 309.

For example, as illustrated in FIGS. 5 and 9, “0”, “T1”, and “T2” in the time 402 of data registered in the reference waveform data table 306 are changed to “0”, “Rx*T1”, and “Rx*T2”, respectively, at a correction waveform, and “Xt0”, “Xt0+Rx*T1”, and “Xt0*Rx*T2” are recorded respectively in the date and time 703 of the current waveform measurement log table 309.

The waveform analysis unit 210 updates the current waveform feature value table 310 in addition to the current waveform measurement log table 309 (s1309). Specifically, for example, the waveform analysis unit 210 generates a new record in the current waveform feature value table 310, and stores the sensor ID (in the present embodiment, “sensor a”) of the monitoring sensor 104A in the sensor identification information 801 of the generated record, the set target waveform ID “X” in the measurement waveform identification information 802 thereof, a starting point date and time (in the present embodiment, the correspondence event point date and time) “Xt0” the starting point date and time 803 thereof, and the time axial expansion/contraction ratio “Rx” in the time axial expansion/contraction ratio 804 thereof.

Subsequently, as illustrated in FIG. 15, the waveform analysis unit 210 determines (or detects) abnormality of the target waveform by analyzing the already acquired target waveform from the starting point of the target waveform to the correspondence singular point (specifically, the measurement value of the target waveform from the starting point date and time Xt0 to the correspondence singular point date and time Xtj) based on the correction waveform generated at s1308 (s1310). In this analysis method, an abnormality degree is calculated by using, for example, the Euclidean distance or a correlation coefficient between the target waveform and the correction waveform, and compared with a predetermined threshold to determine abnormality of the target waveform. For example, the waveform analysis unit 210 determines that the target waveform is abnormal when the calculated abnormality degree is equal to or larger than the predetermined threshold.

The waveform analysis unit 210 records the calculated abnormality degree in the abnormality degree 805 of the current waveform feature value table 310.

For example, in the example illustrated in FIG. 16, when the Euclidean distance is used in the above-described analysis method, the abnormality degree (Ti) in a time slot from the starting point date and time Xt0 to the correspondence singular point date and time Xtj (in other words, Xt0+Rx×Ti) in the target waveform is calculated by Expression (3) below.

$$Abnormality ( Ti ) = \sqrt{{\sum }_{l = 0}^{i} {( x ( l ) - A ( l ) )}^{2}} \qquad Expression ( 3 )$$

In the expression above, x(l) represents the measurement value of the target waveform at a date and time Xtl (in other words, Xt0+Rx×Tl), and A(l) represents the prediction value (in other words, the measurement value of the reference waveform at a date and time Tl) of the correction waveform at the date and time Xtl (in other words, Xt0+Rx×Tl).

At s1311, when the waveform analysis unit 210 does not determine that the target waveform is abnormal (No at s1311), the current waveform measurement log table 309 is updated (s1312). When the waveform analysis unit 210 determines that the target waveform is abnormal (Yes at s1311), the waveform analysis unit 210 emits an alert (s1321), and thereafter performs processing at s1312. The current waveform measurement log update processing at s1312 is similar to the current waveform measurement log table update processing at s1309. Specifically, the waveform analysis unit 210 records a new record in the current waveform measurement log table 309 based on the measurement value of the target waveform acquired at or after the correspondence singular point date and time Xtj.

At s1313, through processing similarly to that at s1310, the waveform analysis unit 210 analyzes the measurement value of the target waveform acquired at or after the correspondence singular point date and time Xtj based on the reference waveform (in other words, the correction waveform) corrected at s1308, and determines abnormality of the target waveform. The calculated abnormality degree is recorded in the abnormality degree 805 of the current waveform feature value table 310.

In the example illustrated in FIG. 16, for example, the waveform analysis unit 210 calculates an abnormality degree at each date and time at or after the correspondence singular point date and time Xtj (in other words, Xt0+Rx×Ti) by Expression (3). Specifically, the abnormality degrees (Ti+1) to (Tm) are each calculated as needed by substituting an integer in the range of i+1 to m into i in Expression (3).

When the processing at s1313 determines that the target waveform has no abnormality (No at s1314), the waveform analysis unit 210 checks whether to end the target waveform determination processing (s1315). When the processing at s1313 determines that the target waveform has abnormality (Yes at s1314), the singular point calculation unit 209 emits an alert (s1317), and thereafter performs processing at s1315.

At s1315, when it is determined that the target waveform determination processing is to be ended (Yes at s1315), the waveform analysis unit 210 ends the target waveform determination processing (s1319). When it is not determined that the target waveform determination processing is to be ended (No at s1315), the waveform analysis unit 210 performs the processing at s1312 again.

The determination of whether to end the target waveform determination processing at s1315 is processing of determining whether the target waveform is acquired for one period. The determination is performed, for example, by Expression (4) based on the starting point date and time Xt0, the expansion/contraction ratio Rx, and the period Tm of the present reference waveform.

Date_and_Time≥Xt0+Rx*Tm Expression (4)

In the above expression, “date and time” represents the current date and time.

The above-described processing at s1312 to s1317 is repeatedly executed as needed each time the waveform analysis device 101 receives the measurement value of the target waveform from the monitoring sensor 104A.

When the singular point calculation unit 209 determines that the target waveform is abnormal and emits an alert in the above-described target waveform analysis processing, the singular point calculation unit 209 may interrupt analysis processing depending on the magnitude of the abnormality degree. When the event detection unit 207 newly senses an event during execution of the target waveform analysis processing, the waveform analysis unit 210 may interrupt the present processing and execute the target waveform analysis processing based on the new event, or may end the present processing and then execute the target waveform analysis processing based on the new event. Alternatively, the waveform analysis unit 210 may execute a plurality of processes of the target waveform analysis processing in parallel.

Although the abnormality degree is calculated by using the Euclidean distance in Expression (3) in the above-described method, the abnormality degree (Ti) may be calculated by using, instead of or together with the cumulative sum from the starting point date and time in Expression (3), the sum of each Euclidean distance between the number of points right before the singular point date and time in Expression (5) below.

$$Abnormality ( Ti ) = \sqrt{{\sum }_{l = i - n}^{i} {( x ( l ) - A ( l ) )}^{2}} \qquad Expression ( 5 )$$

Expression (5) represents calculation of the abnormality degree by using a measurement value at the date and time Ti (in other words, the singular point date and time) of the present reference waveform, n measurement values of the present reference waveform right before and the measurement value of the target waveform corresponding to each date and time.

Similarly to Expression (3), the abnormality degree can be calculated at an optional date and time at or after the singular point date and time (in other words, at or after the correspondence singular point date and time) by substituting an arbitrary value in the range of i+1 to m into i in Expression (5).

<<Exemplary Display of Target Waveform Analysis Processing>>

The following describes an exemplary screen output through the target waveform analysis processing.

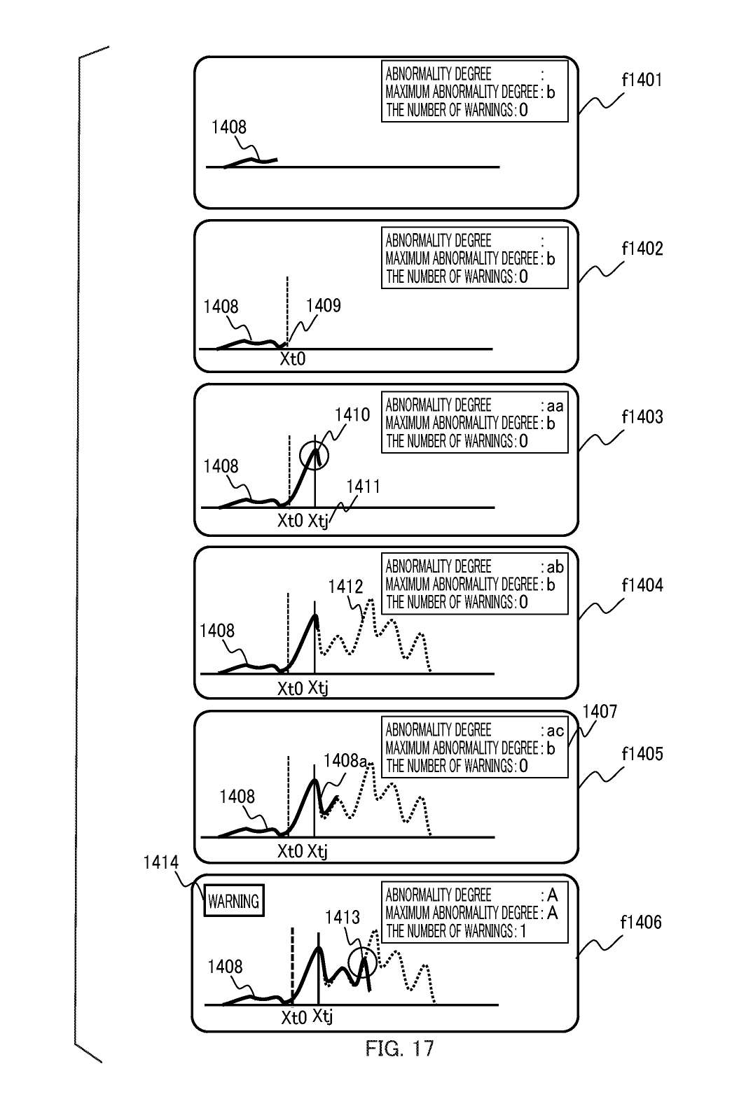

FIG. 17 is a diagram illustrating an exemplary screen on which each temporally changing waveform is displayed in the target waveform analysis processing. This screen is output to, for example, the waveform analysis device 101 or the input/output device 103.

As illustrated in FIG. 17, the screen display unit 211 first sequentially displays a measurement value 1408 (in other words, the target waveform) received by the measurement value reception unit 208 (f1401).

When the event detection unit 207 detects a correspondence event point 1409, the screen display unit 211 adds the corresponding information of the correspondence event point 1409 to the display (f1402).

Subsequently, when the singular point calculation unit 209 calculates the correspondence singular point 1410 of the target waveform, the screen display unit 211 adds a date and time 1411 of the correspondence singular point 1410 to the screen display (f1403).

Subsequently, the screen display unit 211 adds a correction waveform 1412 generated by the waveform analysis unit 210 to the display (f1404), and displays a newly received measurement value 1408a of the target waveform as needed (f1405). In FIG. 17, the correction waveform 1412 is illustrated with a dotted line, but may be illustrated with a line having a color and a thickness different from those of the target waveform.

When the abnormality degree of the target waveform increases and the waveform analysis unit 210 emits an alert, the screen display unit 211 may display a warning 1414 and may display, in an enhanced manner, part 1413 of the target waveform where the abnormality degree is large (f1406).

The screen display unit 211 may display information 1407 such as the current abnormality degree of the target waveform, a past maximum abnormality degree of the target waveform, or the number of times of warning (in other words, the number of times of emission of an alert). The screen display unit 211 may display the above-described screen on the entire screen of the input/output device 103 or part thereof. The screen display unit 211 may always display the above-described screen or may display the above-described screen in response to alert generation or a request from an administrator. The screen display unit 211 does not necessarily need to display a date, but may display a time, and the display may include seconds. The screen display unit 211 may clear the currently displayed screen and display a screen illustrated in f1401 again, when the target waveform is acquired for one period, when a certain time has elapsed, or when a new target waveform is received.

As illustrated in FIG. 17, the screen display unit 211 does not need to output the target waveform together with the correction waveform obtained by correcting the present reference waveform. Instead, the screen display unit 211 may output the present reference waveform together with a waveform (in other words, a waveform obtained by correcting the target waveform) obtained by multiplying the target waveform by the reciprocal of the expansion/contraction ratio Rx.

As described above, the abnormal waveform sensing system 1 according to the present embodiment detects, based on an event point and a singular point in an identical period of the present reference waveform, the correspondence event point of the target waveform and the correspondence singular point existing in the period of the target waveform to which the correspondence event point belongs, determines whether a target waveform newly acquired has abnormality by calculating the dissimilarity degree (in other words, the abnormality degree) between the correction waveform of the present reference waveform and the target waveform based on these four points, and outputs information on the determination. In this manner, once the correspondence event point of the target waveform and the correspondence singular point are specified, abnormality of the target waveform can be determined as needed in response to reception of a measurement value of the target waveform.

As described above, the abnormal waveform sensing system 1 according to the present embodiment can fast sense abnormality of a waveform, and is capable of performing, for example, analysis and abnormality sensing of the target waveform in real time.

The abnormal waveform sensing system 1 according to the present embodiment generates, based on the difference between an event point and a singular point and the difference between the correspondence event point and the correspondence singular point, a correction waveform as a waveform obtained by correcting the present reference waveform, and calculates the dissimilarity degree based on the generated correction waveform, thereby objectively and accurately determining abnormality of a waveform.

Specifically, for example, the abnormal waveform sensing system 1 according to the present embodiment calculates the dissimilarity degree based on the time axial expansion/contraction ratio, thereby accurately determining abnormality of a waveform based on the difference between the periods of waveforms.

In the present embodiment, the processing of determining abnormality of a target waveform is performed based on the time axial expansion/contraction ratio as an exemplary expansion/contraction ratio. However, abnormality of a target waveform may be determined based on the measurement value axial expansion/contraction ratio. In this case, at detection of the correspondence singular point of the target waveform, the abnormal waveform sensing system 1 calculates the measurement value axial expansion/contraction ratio based on a ratio between the measurement value of the target waveform at the correspondence singular point and the measurement value of the present reference waveform at the singular point, and corrects the present reference waveform by multiplying the measurement value of the present reference waveform recorded in the reference waveform data table 306 by the expansion/contraction ratio. Details thereof will be described in an embodiment later.

The abnormal waveform sensing system 1 according to the present embodiment calculates the allowable range of a target waveform based on an event point and a singular point (by using, for example, the time axial maximum expansion/contraction ratio and the time axial minimum expansion/contraction ratio), and determines that a target waveform newly acquired has abnormality when the target waveform is out of the allowable range, thereby correctly detecting abnormality of the target waveform when, for example, error occurs at waveform measurement.

In the abnormal waveform sensing system 1 according to the present embodiment, an event point of the reference waveform is part of the reference waveform when a predetermined device (in other words, the monitoring target device 105) performs a predetermined operation, and the abnormal waveform sensing system acquires a measurement value related to an operation periodically performed by the predetermined device as the value of a target waveform. Thus, abnormality of a waveform can be detected in accordance with an operation of a device by, for example, setting an event based on an operation content of the device. Accordingly, for example, before the monitoring target device 105 is fatally damaged by failure, a user can recognize the abnormality (in other words, a sign of failure) of the target waveform, stop the monitoring target device 105, and perform inspection and repair of a damaged part. This improves the availability of the monitoring target device 105.

In the present embodiment, the event sensor 104B measures each physical quantity and detects an event, but the event detection may be performed by the waveform analysis device 101 instead of the event sensor 104B. In this case, the event sensor 104B sequentially transmits a measurement value of each physical quantity together with a sensor ID and a measurement date and time to the waveform analysis device 101. The event detection unit 207 receives information including each measurement value and detects the occurrence of an event when the received measurement value matches with a condition set in advance.

In the present embodiment, an object from which a measurement value is acquired by a sensor is a manufacturing device in a factory, but not limited thereto. The present embodiment is applicable to various objects that perform operation for which the same waveform repeatedly appears in temporally sequential data. For example, a sensor installed in a plant automatically controlled by process automation, or a sensor installed on a structure such as a bridge or a building may be an object from which a measurement value is obtained.

### Embodiment 2

Embodiment 1 assumes a combination of the single monitoring target device 105 and the single monitoring sensor 104A, but the present invention is applicable to a case with a plurality of combinations of the monitoring sensor 104A and the monitoring target device 105. Such a case will be described in the present embodiment. The description of the present embodiment will be mainly made on any feature different from that of Embodiment 1.

In the present embodiment, the waveform analysis device 101 has functions as described below.

First, the dissimilarity degree calculation unit calculates a dissimilarity degree between each of a plurality of the reference waveforms and the newly acquired the target waveform based on the event point and the singular point of the reference waveform and the correspondence event point and the correspondence singular point of the target waveform.

Then, the abnormality determination unit determines whether the target waveform has abnormality based on each calculated dissimilarity degree, determines that the reference waveform corresponding to the dissimilarity degree determined to be abnormal is not a reference waveform valid for the target waveform, and outputs, when having determined that the target waveform has abnormality based on all calculated dissimilarity degrees, information indicating the abnormality of the target waveform.

In the present embodiment, the reference waveform data table 306 and the reference waveform feature value registration table 307 have contents different from those in Embodiment 1.

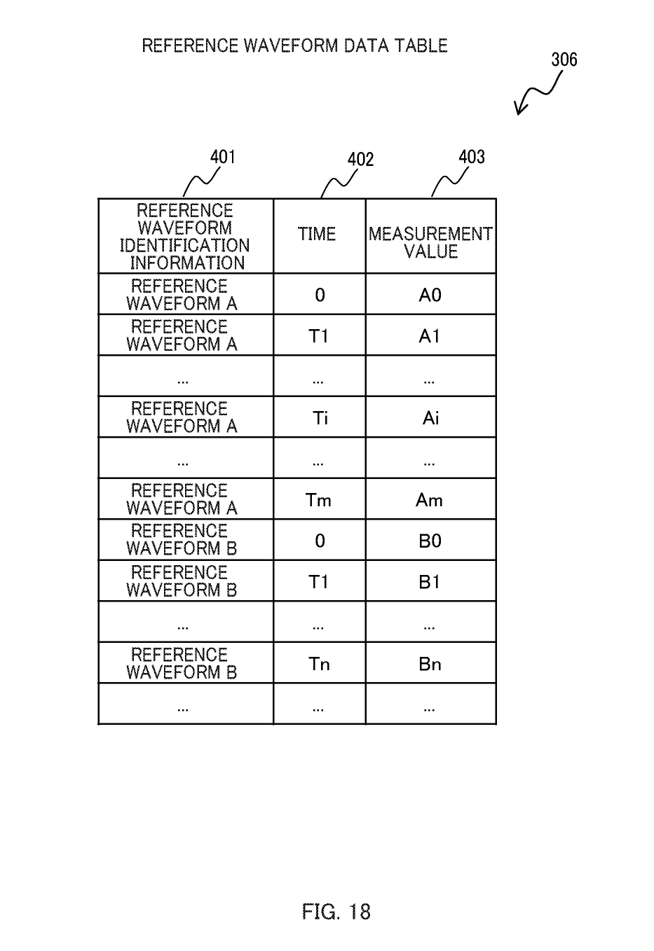

FIG. 18 is a diagram illustrating an exemplary reference waveform data table 306 according to Embodiment 2. As illustrated in FIG. 18, a reference waveform (such as “reference waveform A” or “reference waveform B”) expressed by a measurement value acquired by each of a plurality of the monitoring sensors 104A is registered in the reference waveform data table 306.

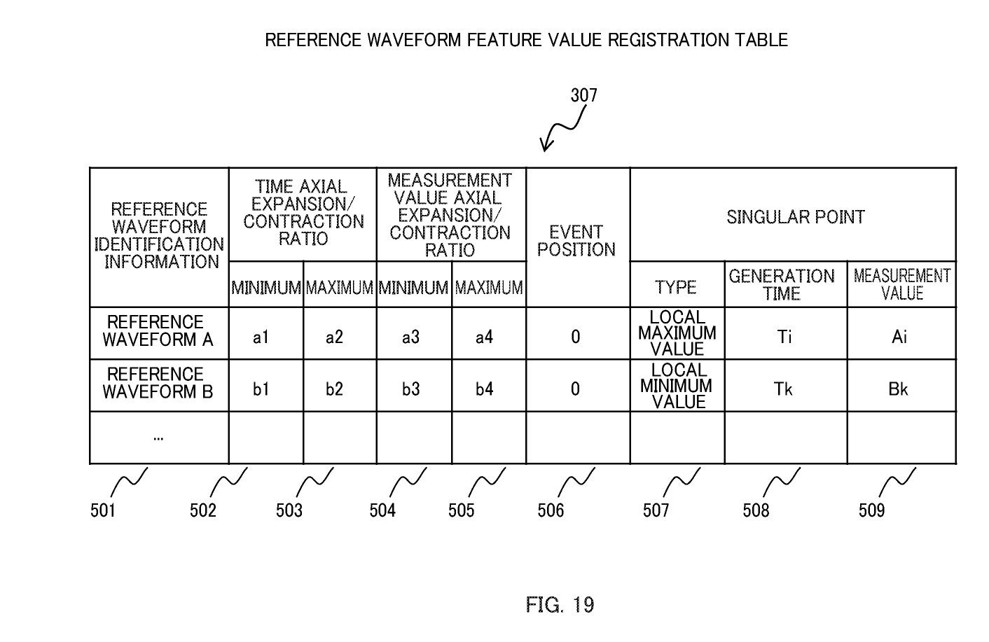

FIG. 19 illustrates an exemplary reference waveform feature value registration table 307 according to Embodiment 2. Similarly to the above-described reference waveform data table 306, information on a plurality of reference waveforms (such as “reference waveform A”, “reference waveform. B”, and the like) is registered in the reference waveform feature value registration table 307.

In the present embodiment, association of the monitoring sensors 104A with each reference waveform is performed by a user.

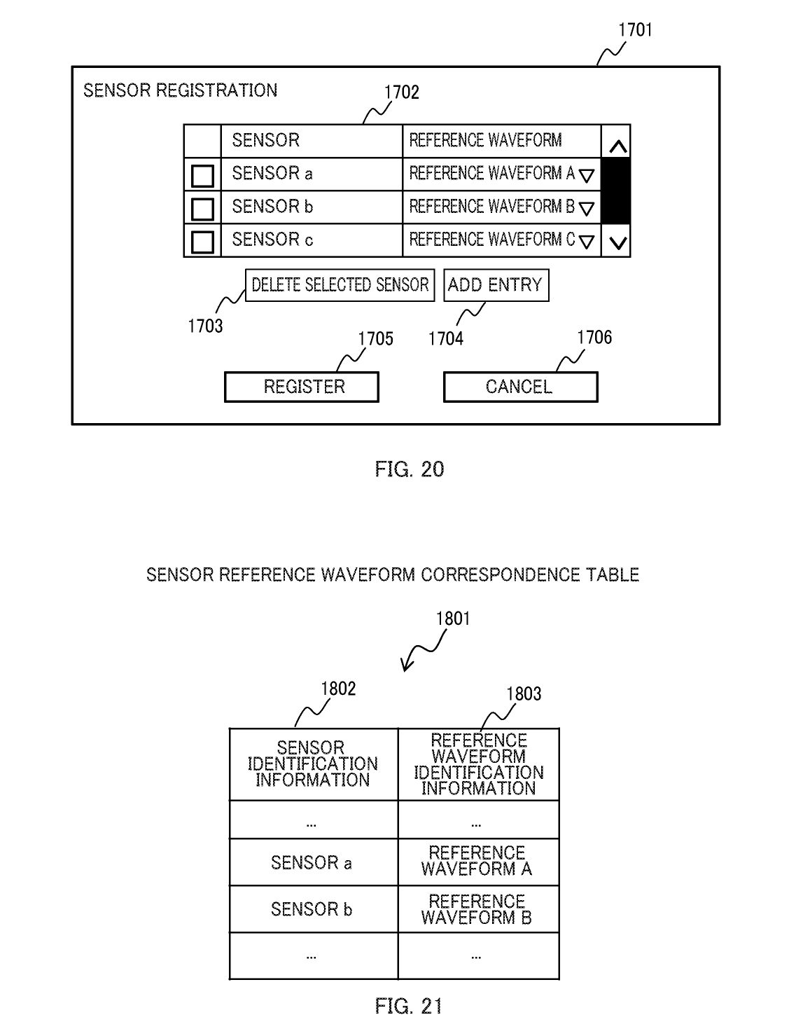

FIG. 20 is a diagram illustrating an exemplary input screen (hereinafter referred to as a sensor registration screen) for associating each monitoring sensor 104A with a reference waveform. This sensor registration screen 1701 is displayed, for example, when the user performs predetermined inputting to the input/output device 103.

The sensor registration screen 1701 includes a sensor registration unit 1702 configured to perform registration of the monitoring sensor 104A and association thereof with a reference waveform, a delete button 1703 configured to delete registration of the monitoring sensor 104A, an addition button 1704 configured to add the above-described association, a registration button 1705 configured to register the above-described association, and a cancel button 1706 configured to cancel the above-described association. The sensor registration screen 1701 may be displayed as part of the reference waveform registration screen 1001.

In the present embodiment, a table is used to store the contents of registration through the sensor registration screen 1701.

FIG. 21 is a diagram illustrating an exemplary sensor reference waveform correspondence table 1801 storing each monitoring sensor 104A in association with a reference waveform. The sensor reference waveform correspondence table 1801 includes at least one record (in other words, entry) including the items of sensor identification information 1802 storing a sensor ID, and reference waveform identification information 1803 storing information (hereinafter referred to as a reference waveform ID) identifying a reference waveform.

For example, when inputting to the registration button 1705 on the sensor registration screen 1701 is performed, the contents of a monitoring sensor 104A and a reference waveform, which are input to the sensor registration screen 1701 are stored in the sensor identification information 1802 and the reference waveform identification information 1803. The sensor reference waveform correspondence table 1801 is stored in, for example, the data storage device 102.

The waveform analysis unit 210 determines abnormality of a target waveform based on the contents of the sensor reference waveform correspondence table 1801 stored in this manner. For example, the waveform analysis unit 210 acquires a combination of a monitoring sensor 104A and a reference waveform from each record in the sensor reference waveform correspondence table 1801, and performs the target waveform analysis processing described in Embodiment 1 on the acquired combination.

### Embodiment 3

Embodiment 1 assumes that an event point of a reference waveform coincides with the starting point of the reference waveform. However, the event point does not always coincide with the starting point. The present embodiment describes a case in which the event point does not coincide with the starting point. The abnormal waveform sensing system 1 in the present embodiment has a system configuration and function same as those of Embodiment 1, and thus description thereof will be omitted. The description of the present embodiment will be mainly made on any difference from Embodiment 1.

The present embodiment first describes an exemplary in which an event point is different from the starting point of a target waveform.

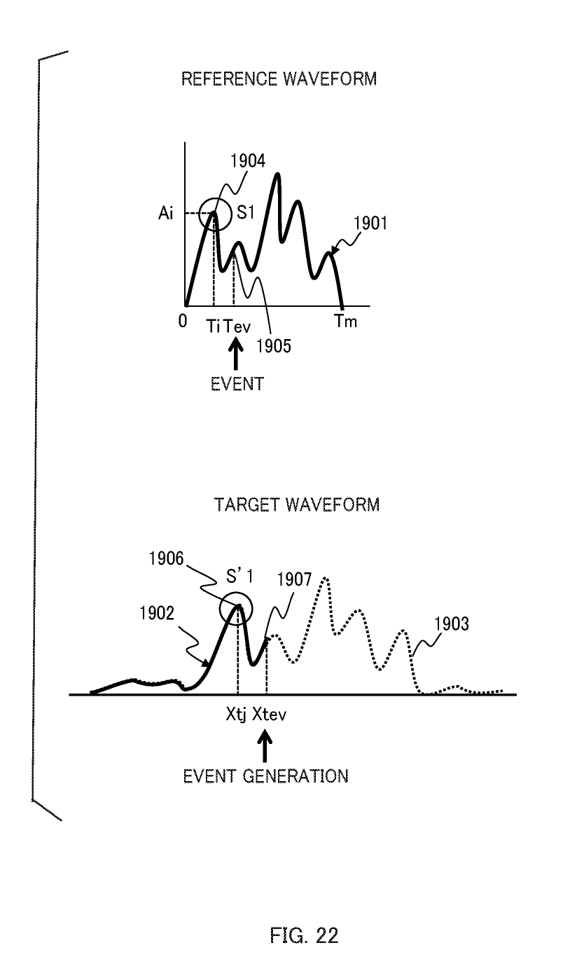

FIG. 22 is a diagram illustrating an exemplary relation between a reference waveform. 1901 and a target waveform 1902 when an event point is different from the starting point of the target waveform. As illustrated in FIG. 22, an event point 1905 of the reference waveform 1901 is located halfway through the period of the reference waveform 1901. Waveform analysis is performed by using the event point 1905 and a singular point 1904.

In the example illustrated in FIG. 22, the event point date and time of the event point 1905 is Tev, and thus “Tev” is recorded in the event position 506 of the reference waveform feature value registration table 307. The value of the event position 506 does not necessarily need to be equal to or larger than zero, but may be a negative value.

<<Target Waveform Analysis Processing>>

The following describes the target waveform analysis processing according to the present embodiment. In the present processing, a reference waveform is “reference waveform A”.

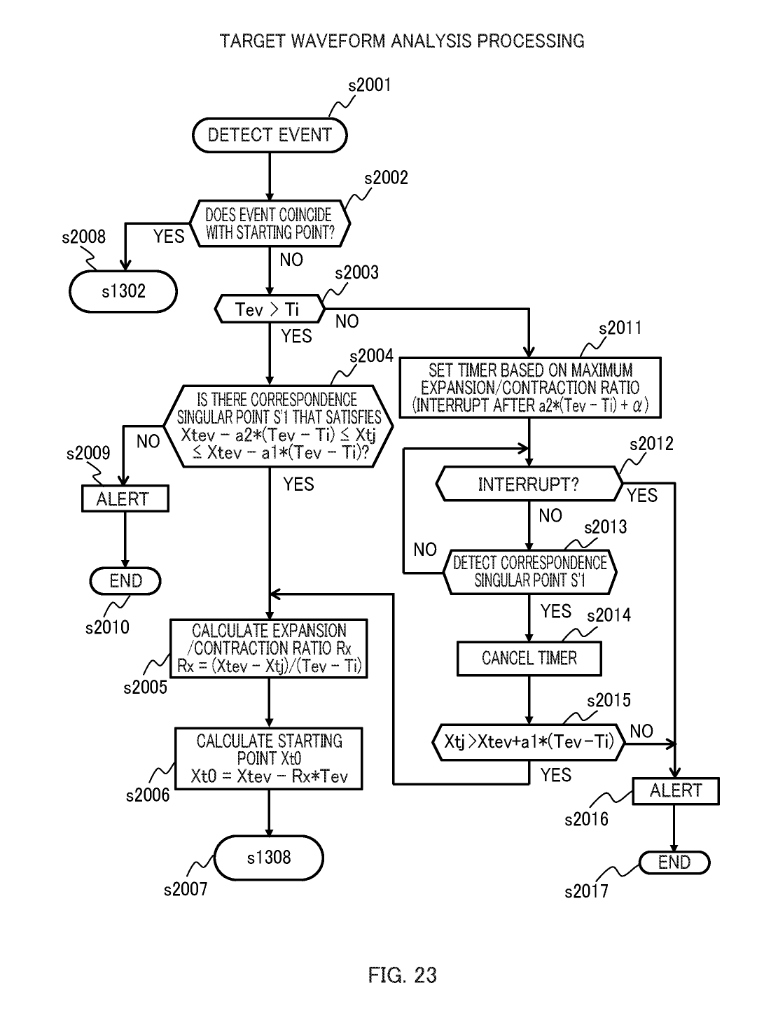

FIG. 23 is a diagram for description of exemplary the target waveform analysis processing according to Embodiment 3. As illustrated in FIG. 23, the event detection unit 207 first detects a correspondence event point 1907 (in the example illustrated in FIG. 22, the correspondence event point date and time is Xtev) (s2001). Then, the event detection unit 207 reads an entry of reference waveform A from the reference waveform feature value registration table 307, and determines whether an event point and a starting point coincide with each other in reference waveform A (in other words, whether the event point date and time is zero) (s2002).

When the event detection unit 207 determines that the event point and the starting point coincide with each other in reference waveform A (Yes at s2002), the processing at s1302 or later in Embodiment 1 is performed (s2008). When the event detection unit 207 determines that the event point and the starting point do not coincide with each other in reference waveform A (No at s2002), the event detection unit 207 acquires the singular point date and time (Ti) and the event point date and time (Tev) of reference waveform A from the reference waveform feature value registration table 307, and compares these to determine which is earlier (s2003). When the singular point date and time is earlier (Yes at s2003), the singular point calculation unit 209 reads data of a target waveform recorded in the measurement log table 308 and checks whether there is a correspondence singular point that satisfies Expression (6) below (s2004).

Xtev−a2{`(Tev−Ti)Xtj≤Xtev−a1*(Tev−Ti) Expression (6)

In the above expression, Xtj represents the generation date and time of the correspondence singular point. In the example illustrated in FIG. 22, the singular point calculation unit 209 checks existence of a correspondence singular point 1906.

When there is a correspondence singular point that satisfies Expression (6) (Yes at s2004), the singular point calculation unit 209 calculates the current expansion/contraction ratio Rx by Expression (7) (s2005).

Rx=(Xtev−Xtj)/(Tev−Ti) Expression (7)

Then, the waveform analysis unit 210 calculates a date and time Xt0 at the starting point of the target waveform based on the expansion/contraction ratio Rx by Expression (8) below (s2006).

Xt0=Xtev−Rx*Tev Expression (8)

Thereafter, the processing at s1308 or later in Embodiment 1 is performed (s2007).

When there is no singular point that satisfies Expression (6) at s2004 (No at s2004), the singular point calculation unit 209 emits an alert (s2009), and the present processing ends (s2010).

When the event point date and time is earlier than or simultaneous with the singular point date and time at s2003 (No at s2003), the singular point calculation unit 209 sets a timer based on the time axial maximum expansion/contraction ratio. Specifically, the event detection unit 207 sets a timer for an interrupt after a2×(Tev−Ti)+α (s2011).

Then, the singular point calculation unit 209 continues detection of a correspondence singular point of the target waveform until an interrupt is caused by the timer (s2012 and s2013).

When having detected a correspondence singular point before an interrupt occurs (Yes at s2013), the singular point calculation unit 209 cancels the timer set at s2011 (s2014). Then, the singular point calculation unit 209 checks whether the date and time of the correspondence singular point detected at s2012 satisfies a condition based on the time axial minimum expansion/contraction ratio (s2015). Specifically, the singular point calculation unit 209 performs the determination by Expression (9) below.

Xtj>Xtev+a1*(Tev−Ti) Expression (9)

When the date and time of the correspondence singular point satisfies the condition (Yes at s2015), the processing at s2005 or later is performed. When the date and time of the correspondence singular point does not satisfy the condition (No at s2015), the singular point calculation unit 209 emits an alert (s2016), and the target waveform analysis processing ends (s2017).

When an interrupt occurs before detection of the correspondence singular point (Yes at s2013), the singular point calculation unit 209 emits an alert (s2016), and the target waveform analysis processing ends (s2017).

In this manner, the abnormal waveform sensing system 1 according to the present embodiment can determine abnormality of a target waveform when an event point and a starting point do not coincide with each other in a reference waveform, and thus this event can be set to a phenomenon that does not coincide with the starting point of the target waveform. Accordingly, an easily detectable phenomenon can be selected as an event from among various kinds of phenomena, and abnormality of the target waveform can be detected based on this event.

In the above-described example, the date and time of the event point is earlier than the date and time of the singular point, but this temporal relation is optional. When there is a plurality of singular points, any singular point having date and time close to that of an event point may be employed, or any singular point having a large value change (in other words, being easily understandable) may be employed.

### Embodiment 4

Embodiment 1 assumes the case in which the single monitoring sensor 104A acquires one reference waveform. However, the present embodiment describes a case in which the single monitoring sensor 104A acquires a plurality of reference waveforms. The description of the present embodiment will be mainly made on any feature different from that of Embodiment 1.

First, since a plurality of reference waveforms are used in the present embodiment, a user registers a plurality of reference waveforms in the reference waveform data table 306 and the reference waveform feature value registration table 307, similarly to Embodiment 2. The user also registers the reference waveforms for the one monitoring sensor 104A in the sensor reference waveform correspondence table 1801. In the present embodiment, the waveform log table 311 may additionally include identification information of each reference waveform.

In the present embodiment, to which of the reference waveforms a target waveform corresponds most needs to be determined in the target waveform analysis processing.

When the waveform ID of a reference waveform corresponding to the target waveform is already registered, the determination can be performed based on the registered waveform ID.

However, when no correspondence relation between a reference waveform and a target waveform is registered, the correspondence relation between a target waveform and a reference waveform is determined to specify an appropriate reference waveform as described below.

The following description assumes that an event point of a reference waveform coincides with the starting point thereof, similarly to Embodiment 1.

<<Target Waveform Analysis Processing>>

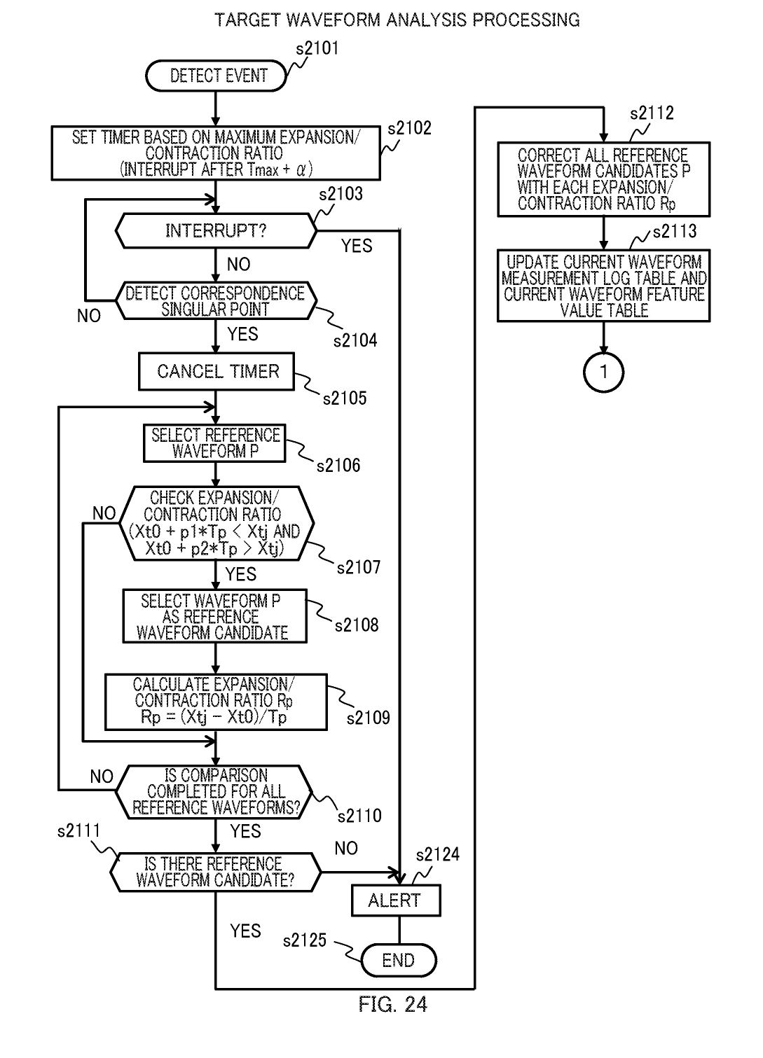

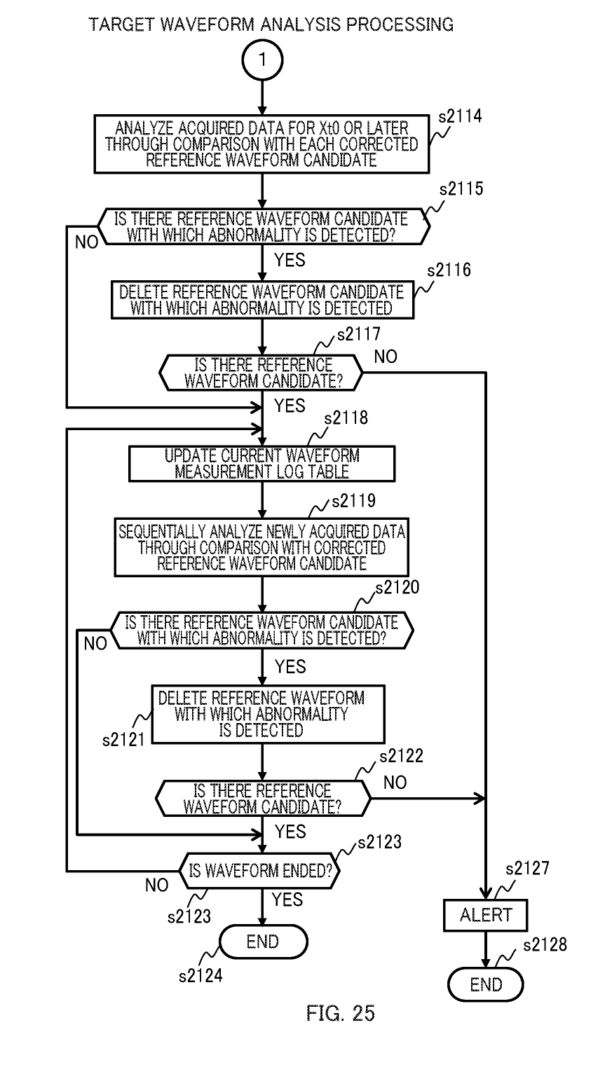

FIGS. 24 and 25 is a flowchart (divided in two sheets) illustrating exemplary target waveform analysis processing according to Embodiment 4. Details of any processing same as that of the target waveform analysis processing according to Embodiment 1 will be omitted.

First, the event detection unit 207 senses an event by receiving an event notification (s2101). Then, the event detection unit 207 calculates a maximum value (hereinafter referred to as Tmax) of the product of the maximum value 503 of the time axial expansion/contraction ratio and the singular point generation time 508 in all records of reference waveforms registered in the reference waveform feature value registration table 307, and sets a timer for an interrupt after Tmax+α from the current date and time (s2102).

Specifically, the event detection unit 207 sets a timer based on a reference waveform for which a singular point potentially appears latest among the reference waveforms. Tmax may be calculated in advance.

Then, the singular point calculation unit 209 continues detection of a correspondence singular point of a target waveform until an interrupt is caused by the timer set at s1202 (s2103 and s2104).

When having detected a correspondence singular point before an interrupt occurs (Yes at s2104), the singular point calculation unit 209 cancels the timer (s2105), and thereafter processing at s2106 is executed. When the singular point calculation unit 209 detects no correspondence singular point before an interrupt occurs (No at s2103), the waveform analysis unit 210 emits an alert (s2124), and the present processing ends (s2125).

At s2106, the singular point calculation unit 209 selects one reference waveform P from among all reference waveforms recorded in the reference waveform feature value registration table 307, and checks whether the date and time Xtj of the correspondence singular point detected at s2104 satisfies a condition of the time axial minimum expansion/contraction ratio and the time axial maximum expansion/contraction ratio for the reference waveform P (s2107). For example, the singular point calculation unit 209 checks whether Expression (10) is satisfied based on a correspondence event point date and time Xt0, a time axial minimum expansion/contraction ratio p1 and a time axial maximum expansion/contraction ratio p2 of the reference waveform P, and a singular point generation date and time Tp of the reference waveform P.

Xtj>Xt0+p1*Tp

and

Xtj<Xt0+`p2*Tp Expression (10)

When the correspondence singular point date and time Xtj satisfies the condition (Yes at s2107), the singular point calculation unit 209 selects the reference waveform P as a reference waveform candidate for the target waveform (s2108). When the correspondence singular point date and time does not satisfy the condition (No at s2107), processing at s2110 to be described later is performed.

After the processing at s2108, the singular point calculation unit 209 calculates a current expansion/contraction ratio Rp for the reference waveform P based on the singular point date and time Tp of the reference waveform P (s2109). Specifically, for example, the singular point calculation unit 209 calculates the expansion/contraction ratio Rp by Expression (11) below.

Rp=(Xtj−Xt0)/Tp Expression (11)

The singular point calculation unit 209 checks whether the processing at s2107 is performed on all reference waveforms (s2110). When there is any unprocessed reference waveform (No at s2110), the singular point calculation unit 209 repeats the processing at s2106 or later on this reference waveform as the reference waveform P. When the processing has ended for all reference waveforms (Yes at s2110), the singular point calculation unit 209 checks whether any reference waveform is selected as a reference waveform candidate at s2108 (s2111).

When there is one or more selected reference waveform candidates (Yes at s2111), the waveform analysis unit 210 corrects each reference waveform candidate by the expansion/contraction ratio Rp to generate a correction waveform (s2112). Specifically, for example, the waveform analysis unit 210 reads all records of the reference waveform candidate P from the reference waveform data table 306, and multiplies the value of the time 402 of each read record by the expansion/contraction ratio Rp calculated at s2109. Then, similarly to Embodiment 1, the waveform analysis unit 210 updates the current waveform measurement log table 309 and the current waveform feature value table 310 (s2113). In this case, for example, a measurement value at each date and time necessary for comparison with all reference waveform candidates P is registered in the current waveform measurement log table 309. Thereafter, processing at s2114 is performed.

When there is no selected reference waveform candidate (No at s2111), the waveform analysis unit 210 emits an alert (s2124), and the target waveform analysis processing ends (s2125).

As indicated at s2114 in FIG. 25, similarly to Embodiment 1, the waveform analysis unit 210 determines abnormality of the target waveform by analyzing data (specifically, measurement data acquired between date and time Xt0 and date and time Xtj) at or after the starting point of the target waveform based on each correction waveform generated at s2112.

When the waveform analysis unit 210 detects no abnormality of the target waveform (No at s2115), processing at s2118 to be described later is executed. When the waveform analysis unit 210 detects abnormality of the target waveform (Yes at s2115), the waveform analysis unit 210 deletes every reference waveform candidate with which abnormality of the target waveform is detected (in other words, determines the reference waveform candidate to be an invalid reference waveform and excludes the reference waveform candidate) (s2116).

Then, the waveform analysis unit 210 checks whether there remains any reference waveform candidate (s2117). When there remains one or more reference waveform candidates, the current waveform measurement log table 309 is updated, similarly to Embodiment 1 (s2118). Specifically, similarly to the processing of updating the current waveform measurement log table at s1312, the waveform analysis unit 210 records a new record based on the measurement value of the target waveform acquired at or after the correspondence singular point date and time. The record is recorded for any remaining correction waveform candidate. The waveform analysis unit 210 may delete, from the current waveform measurement log table 309, a record corresponding to a reference waveform candidate deleted at s2116.

Then, the waveform analysis unit 210 determines (detects) abnormality of the target waveform by sequentially analyzing the target waveform at or after the correspondence singular point date and time based on each remaining correction waveform candidate (in other words, each reference waveform candidate), similarly to Embodiment 1 (s2119).

When having detected abnormality of the target waveform (Yes at s2120), the waveform analysis unit 210 deletes every reference waveform candidate with which abnormality of the target waveform is detected (in other words, determines the reference waveform candidate to be an invalid reference waveform and excludes the reference waveform candidate) (s2121). Then, the waveform analysis unit 210 determines whether there remains any reference waveform candidate (s2122). When there remains one or more reference waveform candidates (Yes at s2122), the waveform analysis unit 210 determines whether the target waveform is acquired for one period up to now (s2123). When the waveform analysis unit 210 determines that the target waveform is acquired for one period (Yes at s2123), the target waveform analysis processing ends. When the waveform analysis unit 210 determines that the target waveform is yet to be acquired for one period (No at s2123), the processing at s2118 or later is repeated.

At s2120, when the waveform analysis unit 210 detects no abnormality of the target waveform (No at s2120), the processing at s2123 or later is performed.

At s2122, when there remains no reference waveform candidate (No at s2122), the waveform analysis unit 210 emits an alert (s2127), and the target waveform analysis processing ends (s2128).

<<Screen Output in Target Waveform Analysis Processing>>

The following describes a screen output in the target waveform analysis processing according to the present embodiment.

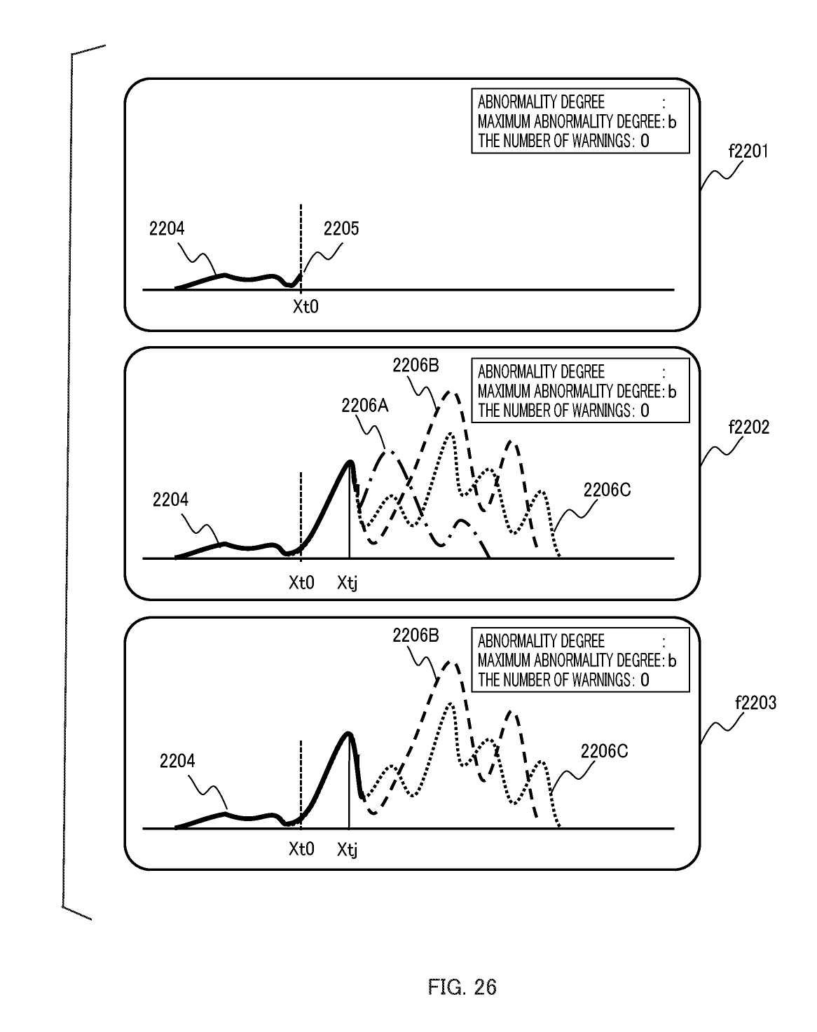

FIG. 26 is a diagram illustrating an exemplary screen output in the target waveform analysis processing. This screen is output to, for example, the input/output device 103. As illustrated in FIG. 26, the screen display unit 211 first sequentially displays data 2204 of a target waveform, and adds, when a correspondence event point is detected, information related to this correspondence event point 2205 to the display (f2201).

Then, when correction waveforms are generated for all reference waveform candidates, the screen display unit 211 adds all correction waveforms 2206 (in the example illustrated in FIG. 26, a correction waveform 2206A, a correction waveform 2206B, and a correction waveform 2206C) to the display (f2202). In addition, when a reference waveform candidate is deleted (in other words, excluded), the screen display unit 211 deletes the waveform of the deleted reference waveform candidate (f2203). Each correction waveform 2206 may be displayed in a color and a thickness different from those of the target waveform and the other correction waveforms 2206.

As described above, when there is a plurality of reference waveforms, the abnormal waveform sensing system 1 according to the present embodiment can select a reference waveform appropriate for a target waveform newly acquired and determine (or detect) abnormality of the target waveform based on the selected reference waveform.

<<Measurement Value Axial Expansion/Contraction Ratio>>

The above embodiments mainly describe waveform analysis using a time axial expansion/contraction ratio. Waveform analysis may be performed by using a measurement value axial expansion/contraction ratio when expansion and contraction in the measurement value axis direction occurs to a reference waveform and a target waveform (in other words, when the values of the reference waveform and the target waveform largely change).

For example, in the present embodiment, determination is performed by Expressions (12) and (13) below in addition to Expression (10) used in the determination (s2107) related to a time axial minimum expansion/contraction ratio for the reference waveform P. When these expressions are all satisfied for the reference waveform P, the singular point calculation unit 209 selects the reference waveform P as a reference waveform candidate.

X1>p3*Ph Expression (12)

X1<p4*Ph Expression (13)

In the above expressions, X1 represents the measurement value of the target waveform at a correspondence singular point, p3 and p4 respectively represent an allowable minimum value (hereinafter referred to as a measurement value axial minimum expansion/contraction ratio) and an allowable maximum value (hereinafter referred to as a measurement value axial maximum expansion/contraction ratio) among measurement value axial expansion/contraction ratios for the reference waveform P that are set in advance, and Ph represents the measurement value of the reference waveform P at a singular point.

In addition to the time value axial expansion/contraction ratio Rp (s2109), the singular point calculation unit 209 calculates a measurement value axial expansion/contraction ratio Qp by Expression (14) below.

Qp=Ph/X1 Expression (14)

In this manner, the singular point calculation unit 209 performs, on the reference waveform, correction in the measurement value axis direction in addition to correction in the time axis direction.

As described above, the abnormal waveform sensing system according to the present embodiment calculates the dissimilarity degree based on the measurement value axial expansion/contraction ratio, thereby accurately determining abnormality of a waveform based on the difference between waveforms in amplitude and displacement.

### Embodiment 5

In the above-described embodiments, the abnormal waveform sensing system 1 detects event generation by notification (in other words, an event notification) from the outside. However, in the present embodiment, the abnormal waveform sensing system 1 detects event generation by regarding one singular point as an event. The description of the present embodiment will be mainly made on any feature different from that of Embodiment 1.

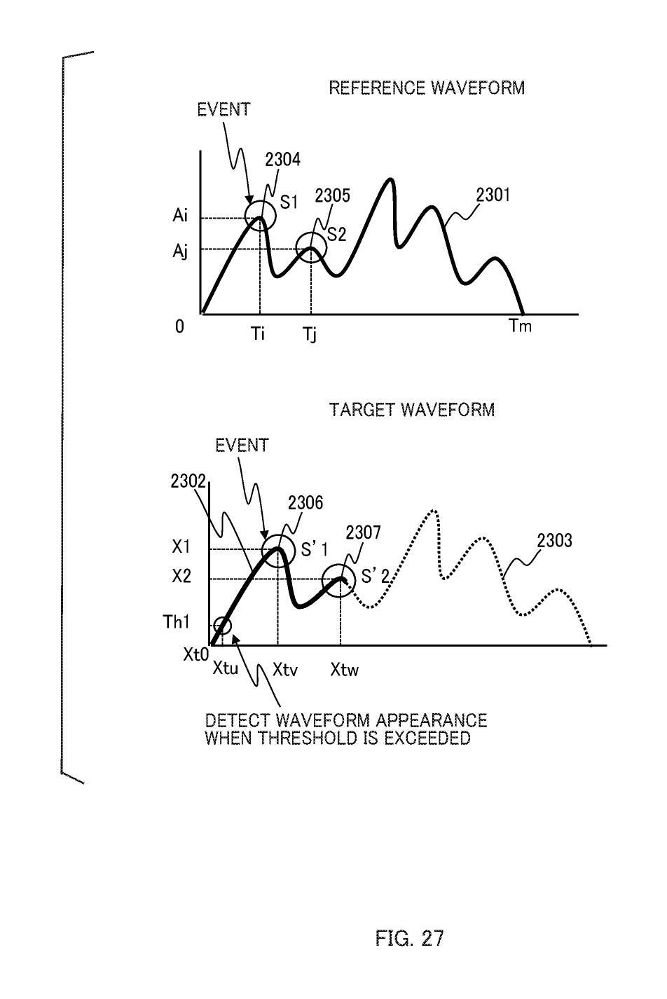

FIG. 27 is a diagram for description of a relation between an event point and a singular point, which is assumed in Embodiment 5. As illustrated in FIG. 27, in the present embodiment, there are a reference waveform 2301, a correction waveform 2303 obtained through correction based on the reference waveform 2301, and a target waveform 2302 on which abnormality determination is performed. The reference waveform 2301 includes a singular point 2304 (hereinafter referred to as a singular point S1) and a singular point 2305 (hereinafter referred to as a singular point S2) as two local maximum values close to the starting point of the reference waveform. The abnormal waveform sensing system 1 according to the present embodiment performs processing of detecting, as an event point, the singular point 2304 (singular point S1), which is closer to the starting point of the reference waveform. The date and time of the singular point S1 is denoted by Ti, and the date and time of the singular point S2 is denoted by Tj.

The target waveform 2302 includes a correspondence singular point (hereinafter referred to as a correspondence singular point S′1) corresponding to the singular point S1 and a correspondence singular point (hereinafter referred to as a correspondence singular point S′2) corresponding to the singular point S2. The date and time of the correspondence singular point S′1 is denoted by Xtv, and the date and time of the correspondence singular point S′2 is denoted by Xtw.

The reference waveform feature value registration table 307 in the present embodiment as described below is obtained based on the above-described assumption.

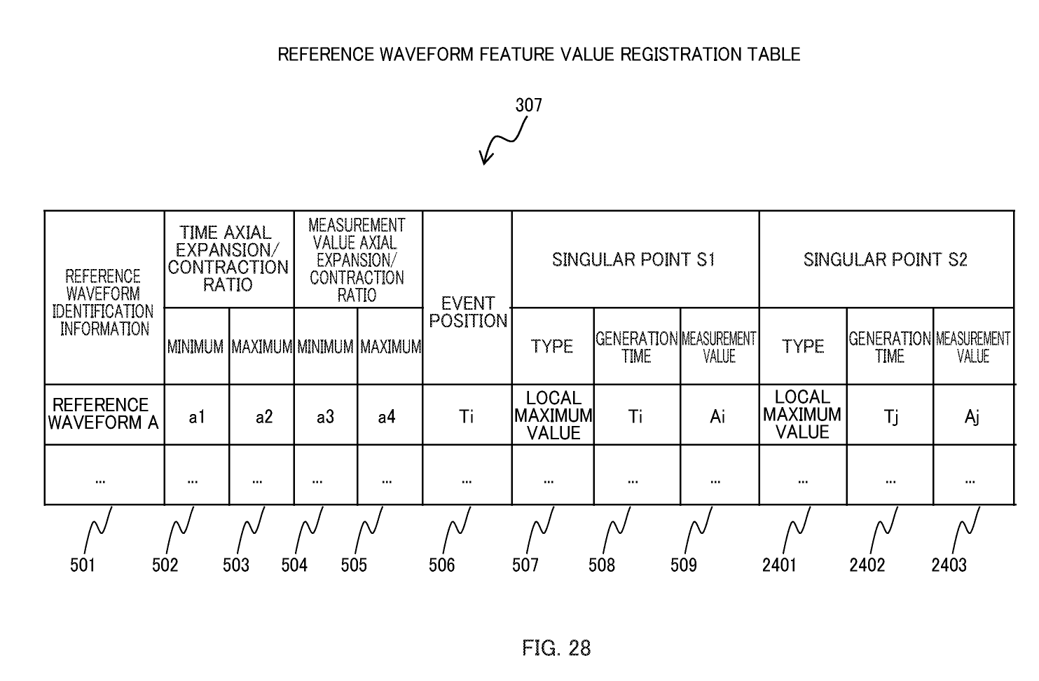

FIG. 28 is a diagram illustrating an exemplary reference waveform feature value registration table 307 in the present embodiment. As illustrated in FIG. 28, unlike Embodiment 1, the reference waveform feature value registration table 307 includes a plurality of items related to singular points of the reference waveform (in FIG. 28, items (507 to 509) related to the singular point S1 and items (2401 to 2403) related to the singular point S2).

The following describes the target waveform analysis processing according to the present embodiment.

<<Target Waveform Analysis Processing>>

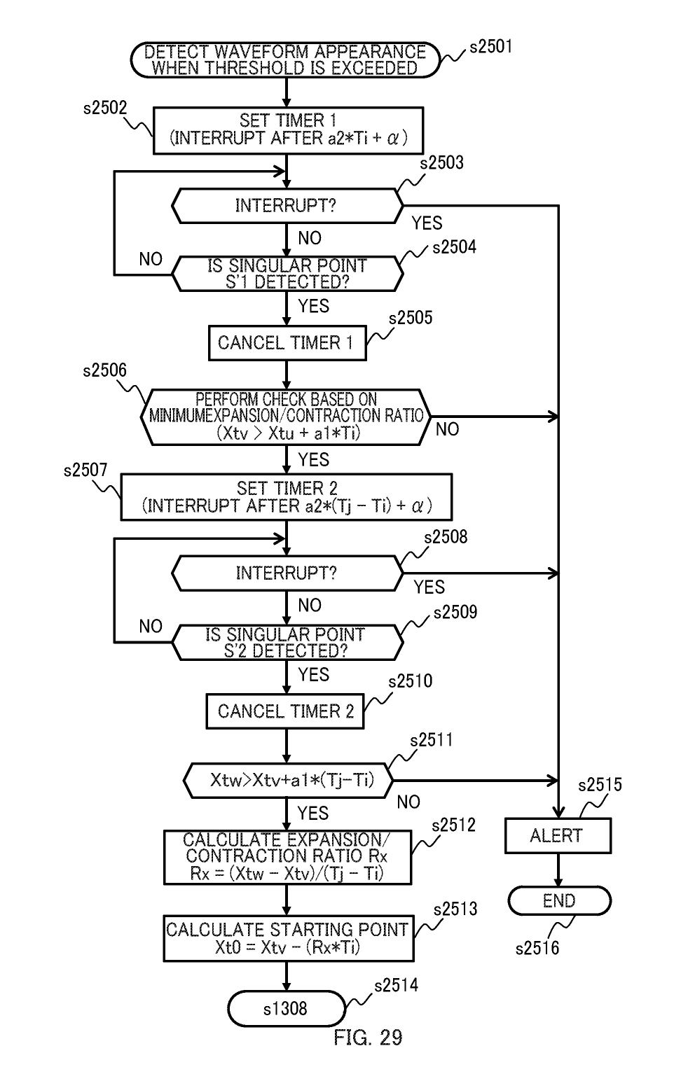

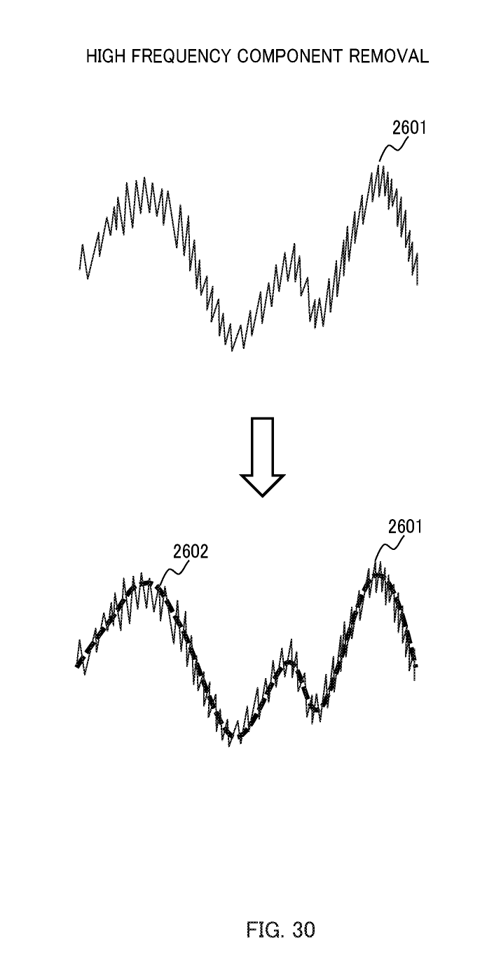

FIG. 29 is a flowchart for description of processing performed in place of s1301 to s1307 in Embodiment 1 in the target waveform analysis processing according to the present embodiment. This processing is started, for example, once a measurement value (in other words, data of a target waveform) received from the waveform analysis device 101 exceeds a predetermined threshold (Th1) (s2501).

As illustrated in FIG. 29, the event detection unit 207 first stores a date and time (in the present embodiment, Xtu) when the measurement value of the target waveform exceeds the threshold (Th1), and sets a timer (hereinafter referred to as a timer 1) for an interrupt after “a2×Ti+α” from the current date and time (s2502).

The singular point calculation unit 209 performs detection of the correspondence singular point S′1 until the interrupt occurs (s2503 and No at s2504).

When the interrupt occurs (Yes at s2503), processing at s2515 to be described later is performed. When having detected the correspondence singular point S′1 (Yes at s2504), the singular point calculation unit 209 stores the current date and time as the date and time Xtv of the correspondence singular point S′1, and cancels the timer 1 (s2505).

Then, the singular point calculation unit 209 determines, by using Expression (15) below, whether the detection date and time Xtv of the correspondence singular point S′1 satisfies a condition based on a time axial minimum expansion/contraction ratio (s2506).

Xtv>Xtu+a1*Ti Expression (15)

When having determined that the date and time Xtv of the correspondence singular point S′1 satisfies the condition (Yes at s2506), the singular point calculation unit 209 sets a timer (hereinafter referred to as a timer 2) for an interrupt after “a2×(Tj−Ti)+α” (s2507).

The singular point calculation unit 209 performs detection of the correspondence singular point S′2 until the interrupt occurs (s2508 and No at s2509).

When the interrupt occurs (Yes at s2508), processing at s2515 to be described later is performed. When having detected the correspondence singular point S′2 (Yes at s2509), the singular point calculation unit 209 stores the current date and time as the date and time Xtw of the correspondence singular point S′2, and cancels the timer 2 (s2510).

Then, the singular point calculation unit 209 determines, by using Expression (16) below, whether the date and time Xtw of the correspondence singular point S′2 satisfies a condition based on the time axial minimum expansion/contraction ratio a1 (s2511).

Xtw>Xtv+a1*(Tj−Ti) Expression (16)

When having determined that the date and time Xtw of the correspondence singular point S′2 satisfies the condition (Yes at s2511), the singular point calculation unit 209 calculates the current expansion/contraction ratio Rx by Expression (17) below based on the date and time Xtv of the correspondence singular point S′1 and the date and time Xtw of the correspondence singular point S′2 (s2512).

Rx=(Xtw−Xtv)/(Tj−Ti) Expression (17)

Subsequently, the waveform analysis unit 210 calculates the starting point Xt0 of the target waveform 2302 by Expression (18) below based on the expansion/contraction ratio Rx (s2513), and thereafter the processing at s1308 or later in Embodiment 1 is performed (s2514).

Xt0=Xtv−(Rx*Ti) Expression (18)

At s2515, the singular point calculation unit 209 emits an alert, and the present processing ends (s2516).

In this manner, the abnormal waveform sensing system 1 according to the present embodiment can determine abnormality of a target waveform based on measurement data obtained from the monitoring sensor 104A without installing an event detection sensor described in Embodiment 1.

### Embodiment 6

The present embodiment describes an exemplary method of removing a high frequency component by applying a lowpass filter. The high frequency component is included in a reference waveform and a target waveform when the monitoring target device 105 is, for example, a rotational machine that generates high frequency vibration. The description of the present embodiment will be mainly made on any feature different from that of Embodiment 1.

The waveform analysis device 101 in the present embodiment includes the high frequency component removal unit 221 in addition to the functions described in Embodiment 1.

The high frequency component removal unit 221 generates a new reference waveform or a new the target waveform by removing part of a reference waveform or a target waveform that changes in a period equal to or larger than a predetermined value.

FIG. 30 is a diagram for description of the principle of the high frequency component removal unit 221 according to Embodiment 6. For example, when a reference waveform and a target waveform are waveforms largely affected by high and low frequency components like a waveform 2601 illustrated in FIG. 30, it is potentially unable to accurately detect a singular point (such as a local maximum value or a local minimum value) of the waveform 2601 in determination of abnormality of the target waveform by using the waveform 2601.

To avoid this, the high frequency component removal unit 221 generates a new waveform 2602 that is free from influence of the high frequency component by applying a lowpass filter to temporally sequential data (in other words, a waveform) of measurement values transmitted from each sensor.

An exemplary lowpass filter is a moving average. For example, the high frequency component removal unit 221 calculates a moving average by using latest n measurement values including the latest measurement value. In this case, a value Yt of the new waveform 2602 at a date and time t can be obtained by Expression (19) below.

$$Yt = \frac{{\sum }_{i = 0}^{n - 1} {X}_{t - i}}{n} \qquad Expression ( 19 )$$

In the above expression, Xt represents a measurement value at the date and time t.

The high frequency component removal unit 221 can generate, by using Yt, the new waveform 2602 that is free from influence of the high frequency component. Data of the generated new waveform. 2602 may be stored in the measurement log table 308 like Embodiment 1 or a newly generated table. An identical lowpass filter or different lowpass filters may be applied to the reference waveform and the target waveform.

In this manner, the abnormal waveform sensing system 1 according to the present embodiment can determine abnormality of a target waveform by applying a lowpass filter to a reference waveform and the target waveform when measurement data of each waveform is largely affected by a high frequency component.

The high frequency component removal unit 221 may constantly perform the lowpass filter processing on a measurement value received from the monitoring sensor 104A, or may perform the lowpass filter processing after extraction of a correspondence event point.

### Embodiment 7

Embodiment 6 describes the method of applying a lowpass filter to a waveform largely affected by both high and low frequency components to remove influence of the high frequency component. The present embodiment describes below a method of processing a waveform largely affected by a high frequency component but not by a low frequency component. The description of the present embodiment will be mainly made on any feature different from that of Embodiment 1.

As illustrated in FIG. 2, the waveform analysis device 101 in the present embodiment includes the auxiliary waveform generation unit 223.

The auxiliary waveform generation unit 223 generates the new reference waveform or the new target waveform by extracting a maximum value, a minimum value, an average value, an intermediate value, or a mode value of the reference waveform or the target waveform in a predetermined section.

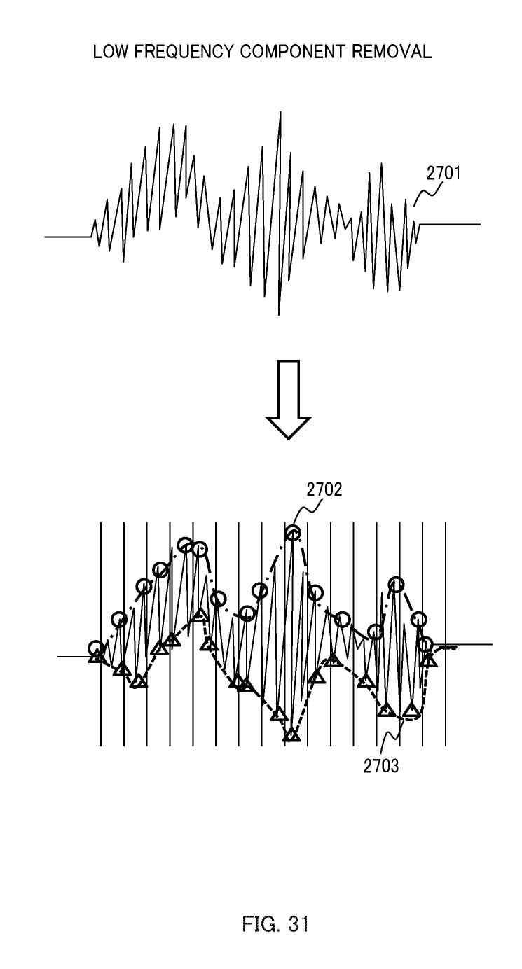

FIG. 31 is a diagram for description of the principle of the waveform processing method according to Embodiment 7. For example, when a reference waveform and a target waveform are each a waveform largely affected by a high frequency component but not by a low frequency component like a waveform 2701 illustrated in FIG. 31, an appropriate waveform cannot be obtained by applying a lowpass filter to this waveform 2701.

To avoid this, the auxiliary waveform generation unit 223 generates a second waveform (hereinafter referred to as an upper waveform) by connecting measurement points having large values among measurement points of the waveform 2701, and generates a third waveform (hereinafter referred to as a lower waveform) by connecting measurement points having small values among the measurement points of the waveform 2701.

For example, as illustrated in FIG. 31, the auxiliary waveform generation unit 223 equally divides the waveform 2701 into sections at an interval equal to or longer than a predetermined time, and acquires a maximum value 2702 and a minimum value 2703 in each time slot. Then, the auxiliary waveform generation unit 223 sets the upper waveform to be temporally sequential data of the acquired maximum values 2702, and sets the lower waveform to be temporally sequential data of the acquired minimum values 2703.

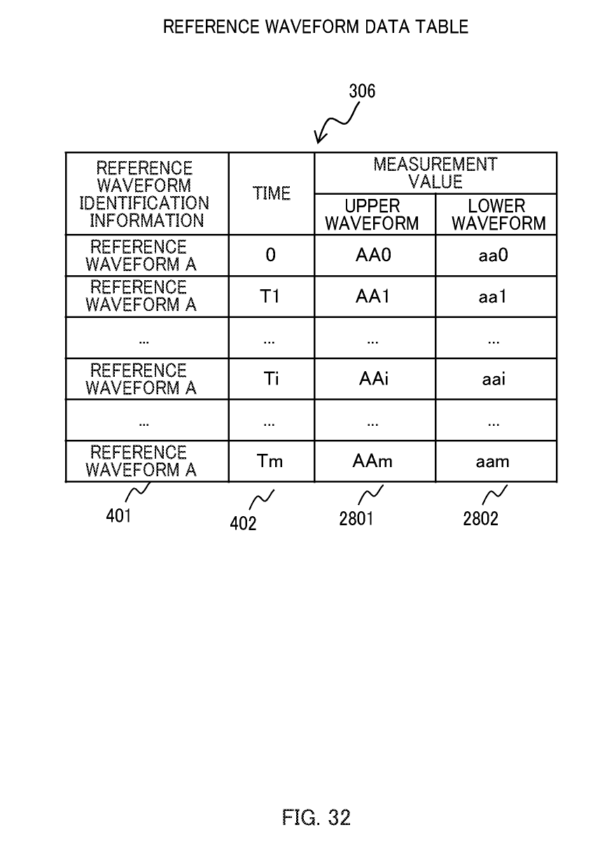

FIG. 32 is a diagram illustrating an exemplary reference waveform data table 306 in the present embodiment. As illustrated in FIG. 32, the reference waveform data table 306 includes, for a record of each date and time, the items of an upper waveform 2801 storing the measurement value of the upper waveform, and a lower waveform 2802 storing the measurement value of the lower waveform.

Similarly to the reference waveform data table 306, the current waveform measurement log table 309 records the measurement value of the upper waveform and the measurement value of the lower waveform for a record of each date and time.

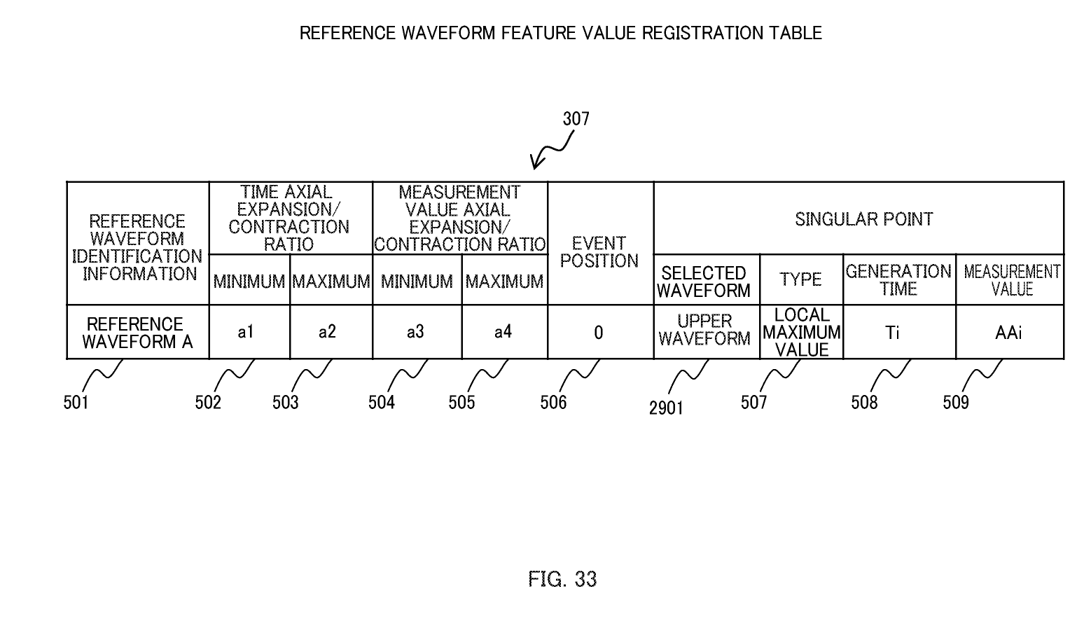

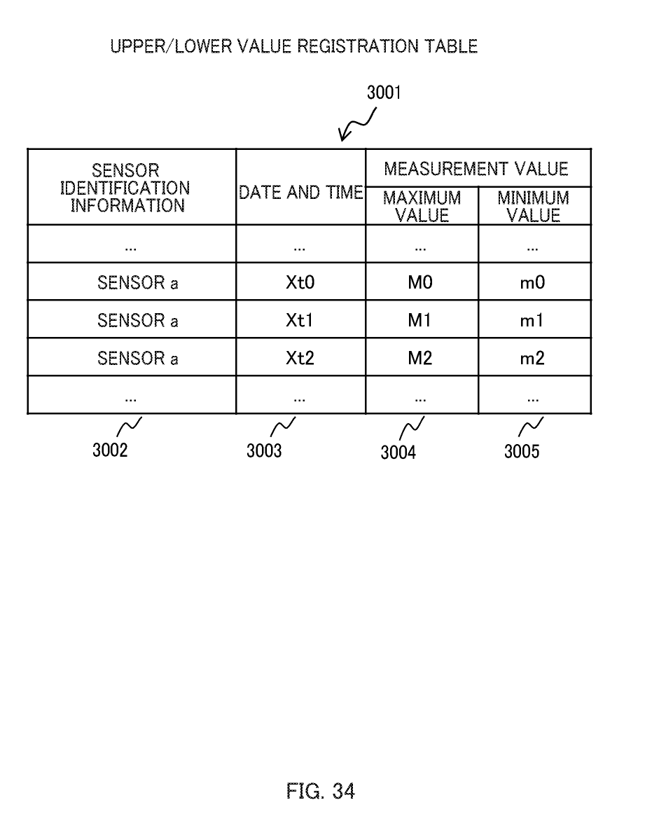

FIG. 33 is a diagram illustrating an exemplary reference waveform feature value registration table 307 in the present embodiment. As illustrated in FIG. 33, the reference waveform feature value registration table 307 includes the item of a singular point selection waveform 2901 in addition to the reference waveform feature value registration table 307 in Embodiment 1. The singular point selection waveform. 2901 stores information indicating whether a singular point is based on the upper waveform or the lower waveform.

In the present embodiment, the data storage device 102 stores information of the upper and lower waveforms as described below, for example.

FIG. 34 is a diagram illustrating an exemplary upper/lower value registration table 3001 storing information of the upper and lower waveforms. As illustrated in FIG. 34, the upper/lower value registration table 3001 includes at least one record (in other words, entry) including the items of sensor identification information 3002 storing a sensor ID, a date and time 3003 storing information for specifying a date and time, a maximum value 3004 storing the value of the upper waveform of a waveform corresponding to the sensor ID stored in the sensor identification information 3002, and a minimum value 3005 storing the value of the lower waveform thereof.

The date and time 3003 stores, for example, a date and time selected from among a start date and time, a middle date and time, and an end date and time of each time slot.

The maximum value 3004 and the minimum value 3005 are each sequentially calculated by, for example, the waveform analysis unit 210 based on data transmitted from the monitoring sensor 104A. These values are used for the target waveform analysis processing.

Thus, the waveform analysis unit 210 performs the target waveform analysis processing by using, as a reference waveform, each of the upper waveform made of the maximum values 3004 and the lower waveform 2802 made of the minimum values 3005. The waveform analysis unit 210 may perform processing up to the calculation of an expansion/contraction ratio Rx in the target waveform analysis processing on any one of the upper waveform and the lower waveform, and may perform the following processing on both of the upper and lower waveforms.

The abnormal waveform sensing system 1 according to the present embodiment can accurately determine abnormality of a target waveform when a reference waveform and the target waveform are each a waveform largely affected by a high frequency component but not by a low frequency component.

### Embodiment 8

The present embodiment describes an exemplary waveform processing method when a measurement interval between measurement values of each waveform is extremely short. The description of the present embodiment will be mainly made on any feature different from that of Embodiment 1.

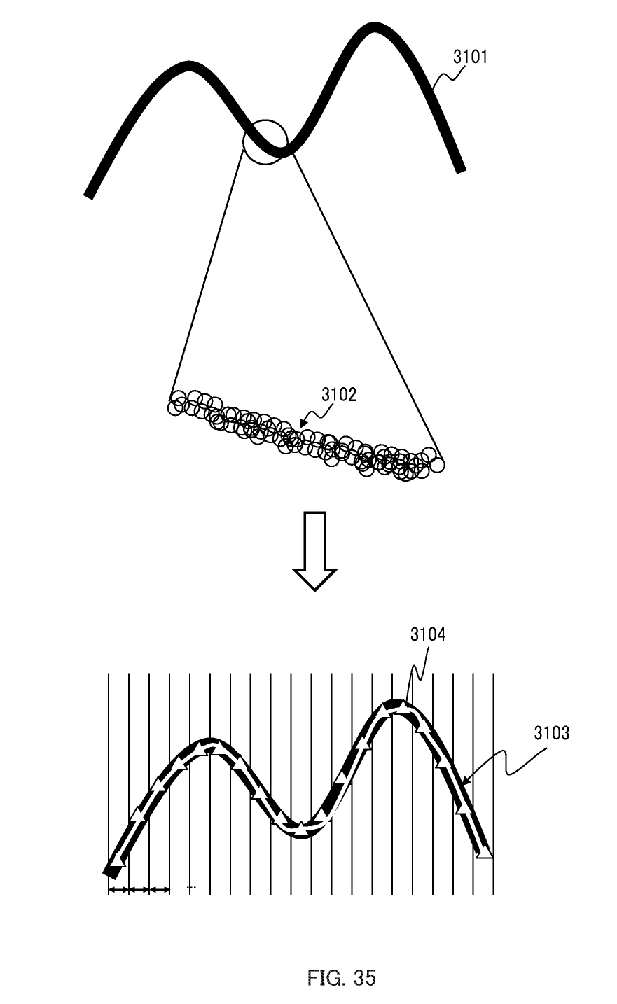

FIG. 35 is a diagram for description of the principle of the waveform processing method according to Embodiment 8. As illustrated in FIG. 35, when a reference waveform or a target waveform includes temporally sequential data 3101 made of a large number of measurement values 3102 measured at an extremely fine time interval, use of all measurement values 3102 as measurement values of the waveform leads to a large calculation amount and difficulties in finding a singular point because of a minute change between the measurement values.

To avoid this, the waveform analysis unit 210 according to the present embodiment sets appropriate sections (in other words, a unit time) in advance, divides the measurement values at the sections, and calculates a representative value 3104 in the unit time for each section. Then, the waveform analysis unit 210 connects the calculated representative values to generate a new waveform 3103. For example, when measurement values are measured at an interval of millisecond, the unit time is set to be one second, and an average value of measurement data for one second is used as a representative value. For example, a median or a mode value may be used in place of the average value.

In the present embodiment, the data storage device 102 may include a representative value registration table (not illustrated) for storing information related to such a representative value. The representative value registration table has a data configuration same as, for example, that of the measurement log table 308 in Embodiment 1, and a representative value is stored in the measurement value 603. For example, the waveform analysis unit 210 registers a representative value calculated from received measurement values to the representative value registration table. Then, the waveform analysis unit 210 performs the target waveform analysis processing based on data recorded in the representative value registration table.

In this manner, the abnormal waveform sensing system 1 according to the present embodiment can accurately determine abnormality of a target waveform when the measurement time interval of measurement data is extremely short.

### Embodiment 9

The present embodiment describes an example in which, when the abnormal waveform sensing system 1 detects abnormality of a target waveform, feedback is performed to the monitoring target device 105 for which the target waveform is measured. The description of the present embodiment will be mainly made on any feature different from that of Embodiment 1.

In the abnormal waveform sensing system 1 according to the present embodiment, the monitoring target device 105 is coupled with the waveform analysis device 101 through the network 106 to perform communication therebetween (not illustrated).

When having detected abnormality of a target waveform, the waveform analysis device 101 has a function of notifying the detection to the monitoring target device 105. Specifically, as illustrated in FIG. 2, the waveform analysis device 101 includes the feedback unit 2103.

When it is determined that the target waveform newly acquired has abnormality, the feedback unit 2103 transmits, to the device, a signal for controlling operation of the device.

In this case, the device operates based on the received signal. For example, when having received the notification from the waveform analysis device 101, the monitoring target device 105 stops operation of the monitoring target device 105 or adjusts the speed of the operation.

<<Feedback Processing>>

The following describes feedback processing according to the present embodiment.

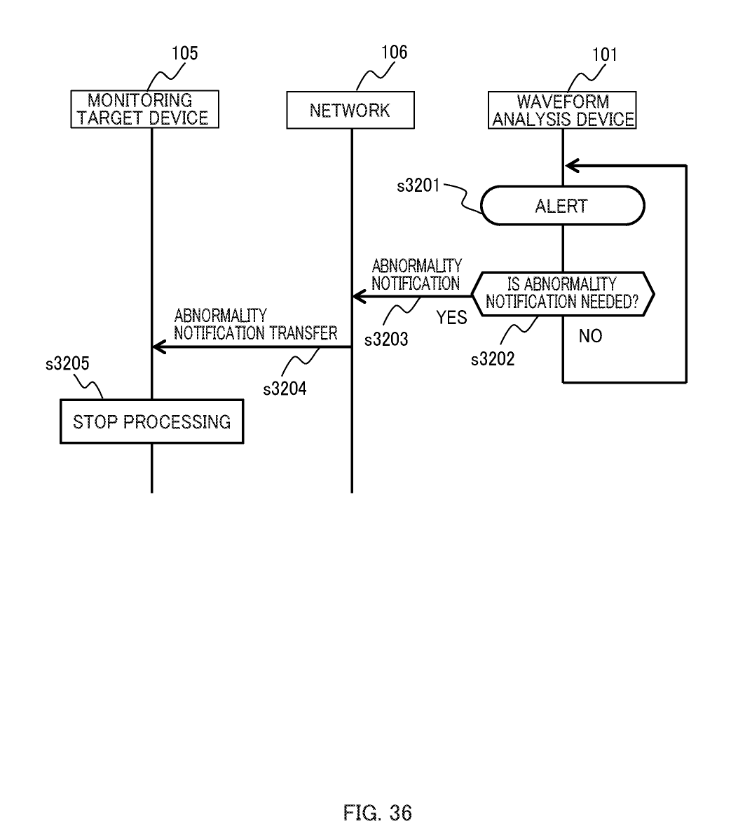

FIG. 36 is a sequence diagram illustrating exemplary processing in which the waveform analysis device 101 performs feedback to the monitoring target device 105. The present processing is performed, for example, when the target waveform analysis processing is started.

As illustrated in FIG. 36, when abnormality of a target waveform is detected (for example, when an alert is emitted) (s3201), the feedback unit 2103 determines whether an abnormality notification is needed. When the abnormality notification is needed (Yes at s3202), the feedback unit 2103 transmits a notification of abnormality of the target waveform to the monitoring target device 105 through the network 106 (s3203 and s3204). When the abnormality notification is not needed (No at s3202), the feedback unit 2103 waits for reception of any next alert.

In the abnormality notification necessity determination (s3202), the waveform analysis device 101 may compare, for example, a calculated abnormality degree or an alert generation frequency in a latest predetermined duration against a threshold set in advance, and transmit the notification when the value exceeds the threshold. When there is a plurality of monitoring sensors 104A, the comparison may be based on conditions different between the monitoring sensors 104A.

When having received the notification from the waveform analysis device 101, the monitoring target device 105 stops operation of the monitoring target device 105 (s3205).

In this manner, the abnormal waveform sensing system 1 according to the present embodiment can control (for example, stop) the monitoring target device 105 immediately after abnormality of a target waveform is detected. Accordingly, the monitoring target device 105 can be appropriately operated.

The above description of the embodiments is intended to facilitate understanding of the present invention, but does not limit the present invention. The present invention may be changed and modified without departing from the scope thereof. The present invention includes any equivalent thereof.

For example, in the embodiments, the data structure of information used by the abnormal waveform sensing system 1 may be optionally selected. A data structure appropriately selected from, for example, a table, a list, a database, and a queue may be used. Thus, each table described in the embodiments may be expressed in a data structure other than that of the table. A plurality of tables may be combined to produce one table. When data stored in each table in the embodiments can be expressed in, for example, a mathematical expression, the mathematical expression may be used in place of the table.

For example, the abnormal waveform sensing system 1 according to the embodiments calculates the abnormality degree of a target waveform based on a correction waveform obtained by correcting a reference waveform with an expansion/contraction ratio and a target waveform newly acquired. However, a waveform obtained by correcting the target waveform with the reciprocal of the expansion/contraction ratio may be generated, a predetermined index (in other words, an index corresponding to the abnormality degree) may be calculated based on this waveform and the reference waveform, and abnormality of the target waveform may be determined based on the calculated index.

Although the present disclosure has been described with reference to exemplary embodiments, those skilled in the art will recognize that various changes and modifications may be made in form and detail without departing from the spirit and scope of the claimed subject matter.

What is claimed is:

1. An abnormal waveform sensing system including a processor and a memory configured to sense abnormality of a target waveform which is a waveform serving as a target, based on a reference waveform which is a waveform serving as a reference and which has a value that changes in a predetermined period, the abnormal waveform sensing system comprising:
a reference part acquisition unit configured to acquire an event point which is part of the reference waveform and which satisfies a predetermined condition, and to extract a singular point which is part of the reference waveform and which exists in a period to which the acquired event point belongs, and has a value that indicates predetermined change;
a target waveform acquisition unit configured to acquire the target waveform;
a target waveform analysis unit configured to determine whether part of the acquired target waveform corresponds to the event point and to acquire, when having determined that part of the acquired target waveform corresponds to the event point, the part as a correspondence event point, and to detect a correspondence singular point which is part of the target waveform and which exists in the period of the target waveform to which the correspondence event point belongs, and corresponds to the singular point of the reference waveform;
a dissimilarity degree calculation unit configured to generate a correction waveform obtained by correcting the reference waveform based on the acquired event point of the reference waveform, the extracted singular point of the reference waveform, the acquired correspondence event point of the target waveform, and the detected correspondence singular point of the target waveform, and to calculate a dissimilarity degree between the generated correction waveform and the target waveform newly acquired;
an abnormality determination unit configured to determine whether the target waveform newly acquired has abnormality based on the calculated dissimilarity degree; and
an alert output unit configured to output information related to the abnormality determination.

2. The abnormal waveform sensing system according to claim 1, wherein
the reference waveform and the target waveform each are represented as a value that temporally changes in a predetermined period, and
the dissimilarity degree calculation unit generates the correction waveform based on a ratio of a time difference between the correspondence event point and the correspondence singular point and a time difference between the singular point and the event point and calculates the dissimilarity degree based on the generated correction waveform.

3. The abnormal waveform sensing system according to claim 1, wherein
the reference waveform and the target waveform each are represented as a value that temporally changes in a predetermined period, and
the dissimilarity degree calculation unit generates the correction waveform based on a ratio of the value of the correspondence singular point and the value of the singular point and calculates the dissimilarity degree based on the generated correction waveform.

4. The abnormal waveform sensing system according to claim 1, wherein the abnormality determination unit calculates an allowable range of the target waveform based on the event point and the singular point and determines that the target waveform newly acquired has abnormality when the target waveform newly acquired is out of the calculated allowable range.

5. The abnormal waveform sensing system according to claim 1, wherein
the event point of the reference waveform is part of the reference waveform when a predetermined device performs a predetermined operation, and
the target waveform acquisition unit acquires, as the value of the target waveform, a measurement value related to an operation periodically performed by the predetermined device.

6. The abnormal waveform sensing system according to claim 1, wherein
the dissimilarity degree calculation unit calculates a dissimilarity degree between each of a plurality of the reference waveforms and the target waveform newly acquired based on the event point and the singular point of the reference waveform and the correspondence event point and the correspondence singular point of the target waveform, and
the abnormality determination unit determines whether the target waveform has abnormality based on each calculated dissimilarity degree, determines that the reference waveform corresponding to the dissimilarity degree determined to be abnormal is not a reference waveform valid for the target waveform, and outputs, when having determined that the target waveform has abnormality based on all calculated dissimilarity degrees, information indicating the abnormality of the target waveform.

7. The abnormal waveform sensing system according to claim 1, further comprising a high frequency component removal unit configured to newly generate the reference waveform or the target waveform by removing part of the reference waveform or the target waveform, which changes in a period equal to or larger than a predetermined value.

8. The abnormal waveform sensing system according to claim 1, further comprising an auxiliary waveform generation unit configured to newly generate the reference waveform or the target waveform by extracting a maximum value, a minimum value, an average value, an intermediate value, or a mode value of the reference waveform or the target waveform in a predetermined section.

9. The abnormal waveform sensing system according to claim 5, further comprising a feedback unit configured to transmit, to the device, a signal for controlling operation of the device when it is determined that the target waveform newly acquired has abnormality, wherein the device operates based on the received signal.

10. The abnormal waveform sensing system according to claim 2, wherein the alert output unit outputs the reference waveform, the waveform calculated based on the time difference ratio, and the acquired target waveform or outputs the target waveform, the waveform calculated based on the time difference ratio, and the reference waveform.

11. The abnormal waveform sensing system according to claim 1, further comprising an input screen output unit configured to output a screen for receiving inputting of the reference waveform.

12. The abnormal waveform sensing system according to claim 1, wherein, when the correspondence singular point is not acquired, the target waveform analysis unit outputs information indicating this acquisition result.

13. The abnormal waveform sensing system according to claim 1, further comprising an input screen output unit configured to output a screen for receiving inputting of the reference waveform, wherein
the reference waveform and the target waveform each are represented as a value that temporally changes in a predetermined period,
the event point of the reference waveform is part of the reference waveform when a predetermined device performs a predetermined operation, and
the singular point is part of the reference waveform where the reference waveform has a local maximum value, a local minimum value, or a value set in advance,
the abnormal waveform sensing system comprises a feedback unit configured to transmit, to the device, a signal for controlling operation of the device when it is determined that the target waveform newly acquired has abnormality,
the device operates based on the received signal,
the target waveform acquisition unit acquires, as the value of the target waveform, a measurement value related to an operation periodically performed by the predetermined device, and
outputs, when the correspondence singular point is not acquired, information indicating this acquisition result,
the dissimilarity degree calculation unit generates the correction waveform based on a ratio of a time difference between the correspondence event point and the correspondence singular point and a time difference between the singular point and the event point and calculates the dissimilarity degree based on the generated correction waveform, or the dissimilarity degree calculation unit generates the correction waveform based on a ratio of the value of the correspondence singular point and the value of the singular point and calculates the dissimilarity degree based on the generated correction waveform,
the dissimilarity degree calculation unit calculates a dissimilarity degree between each of a plurality of the reference waveforms and the target waveform newly acquired based on the singular point and the event point of the reference waveform and the correspondence event point and the correspondence singular point of the target waveform,
the abnormality determination unit determines whether the target waveform has abnormality based on each calculated dissimilarity degree, determines that the reference waveform corresponding to the dissimilarity degree determined to be abnormal is not a reference waveform valid for the target waveform, and outputs, when having determined that the target waveform has abnormality based on all calculated dissimilarity degrees, information indicating the abnormality of the target waveform,
calculates an allowable range of the target waveform based on the event point and the singular point and determines that the target waveform newly acquired has abnormality when the target waveform newly acquired is out of the calculated allowable range, and
the alert output unit outputs the reference waveform, the waveform calculated based on the time difference ratio, and the acquired target waveform, or outputs the target waveform, the waveform calculated based on the time difference ratio, and the reference waveform.

14. An abnormal waveform sensing method of sensing abnormality of a target waveform which is a waveform serving as a target, based on a reference waveform which is a waveform serving as a reference and which has a value that changes in a predetermined period,
the method causing an information processing device including a processor and a memory to execute:
reference part acquisition processing of acquiring an event point which is part of the reference waveform and which satisfies a predetermined condition, and extracting a singular point which is part of the reference waveform and which exists in a period to which the acquired event point belongs, and has a value that indicates predetermined change;
target waveform acquisition processing of acquiring the target waveform;
target waveform analysis processing of determining whether part of the acquired target waveform corresponds to the event point, acquiring, when having determined that part of the acquired target waveform corresponds to the event point, the part as a correspondence event point, and detecting a correspondence singular point which is part of the target waveform and which exists in the period of the target waveform to which the correspondence event point belongs, and corresponds to the singular point of the reference waveform;
dissimilarity degree calculation processing of generating a correction waveform obtained by correcting the reference waveform based on the acquired event point of the reference waveform, the extracted singular point of the reference waveform, the acquired correspondence event point of the target waveform, and the detected correspondence singular point of the target waveform, and calculating a dissimilarity degree between the generated correction waveform and the target waveform newly acquired;
abnormality determination processing of determining whether the target waveform newly acquired has abnormality based on the calculated dissimilarity degree; and
alert output processing of outputting information related to the abnormality determination.

15. The abnormal waveform sensing method according to claim 14, wherein
the reference waveform and the target waveform each are represented as a value that temporally changes in a predetermined period, and
the dissimilarity degree calculation processing generates the correction waveform based on a ratio of a time difference between the correspondence event point and the correspondence singular point and a time difference between the event point and the singular point and calculates the dissimilarity degree based on the generated correction waveform.

16. The abnormal waveform sensing method according to claim 14, wherein
the event point of the reference waveform is part of the reference waveform when a predetermined device performs a predetermined operation, and
the target waveform acquisition processing acquires, as the value of the target waveform, a measurement value related to an operation periodically performed by the predetermined device.

17. A waveform analysis device including a processor and a memory and configured to sense abnormality of a target waveform which is a waveform serving as a target, based on a reference waveform which is a waveform serving as a reference and which has a value that changes in a predetermined period, the waveform analysis device comprising:
a reference part acquisition unit configured to acquire an event point which is part of the reference waveform and which satisfies a predetermined condition, and to extract a singular point which is part of the reference waveform and which exists in a period to which the acquired event point belongs, and has a value that indicates predetermined change;
a target waveform acquisition unit configured to acquire the target waveform;
a target waveform analysis unit configured to determine whether part of the acquired target waveform corresponds to the event point, to acquire, when having determined that part of the acquired target waveform corresponds to the event point, the part as a correspondence event point, and to detect a correspondence singular point which is part of the target waveform and which exists in the period of the target waveform to which the correspondence event point belongs, and corresponds to the singular point of the reference waveform;
a dissimilarity degree calculation unit configured to generate a correction waveform obtained by correcting the reference waveform based on the acquired event point of the reference waveform, the extracted singular point of the reference waveform, the acquired correspondence event point of the target waveform, and the detected correspondence singular point of the target waveform, and to calculate dissimilarity degree between the generated correction waveform and the target waveform newly acquired; and
an abnormality determination unit configured to determine whether the target waveform newly acquired has abnormality based on the calculated dissimilarity degree.

18. The waveform analysis device according to claim 17, wherein
the reference waveform and the target waveform each are represented as a value that temporally changes in a predetermined period, and
the dissimilarity degree calculation unit generates the correction waveform based on a ratio of a time difference between the event point and the singular point and a time difference between the correspondence event point and the correspondence singular point and calculates the dissimilarity degree based on the generated correction waveform.

19. The waveform analysis device according to claim 17, wherein
the event point of the reference waveform is part of the reference waveform when a predetermined device performs a predetermined operation, and
the target waveform acquisition unit acquires, as the value of the target waveform, a measurement value related to an operation periodically performed by the predetermined device.
